(19) United States
(12) Patent Application Publication
(10) Pub. No.: US 2025/0358670 A1
(43) Pub. Date: Nov. 20, 2025

(54) SYSTEMS, METHODS, AND DEVICES FOR DYNAMIC ADAPTATION ACCORDING TO DATA FLOW

(71) Applicant: Apple Inc., Cupertino, CA (US)

(72) Inventors: Neha GOEL, Oceanside, CA (US); Muthukumaran DHANAPAL, San Diego, CA (US); Sreevalsan VALLATH, Dublin, CA (US); Divyaprakash P. BHOJKUMAR, San Jose, CA (US)

(21) Appl. No.: 18/668,067

(22) Filed: May 17, 2024

(51) Int. Cl. H04W 28/02; H04L 47/25

(52) U.S. Cl. CPC H04W 28/0268; H04L 47/25

(57) ABSTRACT

The techniques described herein may include solutions for dynamically adapting processes and resources to different types of channels, data flows, applications, and services. Baseband circuitry and/or a user equipment (UE) may determine a jitter of a logical channel (LCH) based on a corresponding radio link control (RLC) sojourn time, determining a data rate adaptation based on the jitter, and informing a corresponding application of the data rate adaption. Additionally, or alternatively, baseband circuitry and/or a UE can determine and apply a prioritized bit rate for LCHs based on a corresponding jitter. Furthermore, a UE, base station, and/or core network can initiate different protocol data unit (PDU) sessions and/or LCHs, within the same slice, for applications with different quality of service (QOS) and/or key performance indicators (KPIs). These and many other features and examples are described in additional detail with reference to the Figures.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices, such as base stations, to communicate with one another. Some scenarios may involve the allocation of resources to different processes and communications, and the arrangement of channels, data flows, and the like.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example core network (CN) according to one or more implementations described herein.

FIG. 4 is a diagram of an example of flow-specific rate adaptation according to one or more implementations described herein.

FIG. 5 is a diagram of an example of dynamic adaptation by changing a prioritized bit rate (PBR) associated with a data flow of a logical channel (LCH) according to one or more implementations described herein.

FIG. 6 is a diagram of an example of dynamic adaptation by mapping data flows to multiple PDU sessions of a single network slice according to one or more implementations described herein.

FIG. 7 is a diagram of an example data structure for mapping data flows to PDU sessions according to one or more implementations described herein.

FIG. 8 is a diagram of an example of dynamic adaptation by mapping LCHs of data flows to a single PDU session of a single network slice according to one or more implementations described herein.

FIGS. 9-11 are diagrams of example processes for dynamic adaptation according to one or more implementations described herein.

FIG. 12-13 are diagrams of example processes for dynamic adaptation according to one or more implementations described herein.

FIG. 14 is a diagram of an example of components of a device according to one or more implementations described herein.

FIG. 15 is a diagram of example interfaces of baseband circuitry according to one or more implementations described herein.

FIG. 16 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 17 is a diagram of an example of user plane protocol stacks in accordance with one or more implementations described herein.

FIG. 18 is a diagram of an example of control plane protocol stacks in accordance with one or more implementations described herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. UEs and base stations may implement various techniques and communications standards for enabling UEs and base stations to discover one another, establish and maintain connectivity, and exchange information in an ongoing manner. Objectives of such techniques may include dynamically adapting processes and resources to different types of channels, data flows, applications, and services.

A wireless network (e.g., a 5G network) may include one or more types of channels, such as logical channels (LCH), transport channels, and physical channels. Logical channels a be offered by a media access control (MAC) layer to a radio link control (RLC) layer. A LCH can include a control channel that carries control plane (CP) information or a traffic channel that carries user plane packets. Each LCH can be mapped to an RLC channel coming from the RLC layer. Transport channels can be offered by the physical (PHY) layer to the MAC layer. The MAC layer can multiplex logical channels to a transport channel. Whereas logical channels can describe what is carried, transport channels describe can how it is carried. Transport channels can be mapped to physical channels. Physical channels can carry information over an air interface using time and frequency resources. Some physical channels can be standalone channels that do not carry higher-layer information.

A protocol data unit (PDU) may include a single unit of information transmitted among peer entities or layers of a network. Protocol data units (PDUs) of different protocol layers (e.g., RLC, MAC, PHY, etc.) can be re mapped to channel types that suit that layer's functionality and abstraction. For example, the RLC layer can deliver its PDUs to the MAC layer over logical channels; the MAC layer can deliver MAC PDUs to the PHY layer via transport channels; and so on. A PDU may include a unit of information corresponding to a protocol stack layer. For example, an RLC PDU can include an RLC header and data. From an upper layer, the RLC layer can receive an RLC service data unit (SDU). The data part of an RLC PDU is either a complete RLC SDU or an SDU segment. A single RLC PDU can map to a single MAC SDU. Multiple MAC SDUs and control elements (CEs) can be part of a single MAC PDU. A MAC PDU can be packaged as a transport block (TB) and sent via a transport channel to the PHY layer for transmission.

A PDU session can include end-to-end user plane connectivity between a UE and a specific data network (DN) via a user plane function (UPF). A PDU Session can support one or more quality of service (QOS) flows, and there can be a one-to-one mapping between a QoS flow and QoS profile (e.g., all packets belonging to a specific QoS flow can have the same 5G QoS identifier (QI or 5Q1). A QoS can correspond to one of two types of QoS flows: guaranteed bit rate (GBR) QoS flows and Non-GBR QoS flows. The QoS flow can be the finest granularity of QOS differentiation in a PDU session. User plane traffic with the same QFI can receive the same forwarding treatment. Every QoS flow can have a QoS profile that includes QoS parameters and

QoS characteristics. Applicable parameters depend on whether a GBR or non-GBR flow type is being implemented. QoS characteristics can be standardized or dynamically configured.

A data radio bearer (DRB) may include time and frequency resources used to carry data between a UE and a base station. DRBs may provide a communication channel for the transport of higher-layer data (e.g., Internet Protocol (IP) packets) between the UE and the base station. The establishment and configuration of DRBs can be managed by a 5G core network (5GC) and the base station, based on service requirements and network conditions. When a UE establishes a connection with a 5G network, one or more DRBs may be established based on the type of services and applications the UE is using. DRBs can be associated with specific QoS parameters to ensure that the required performance levels (e.g., latency, throughput, etc.) are maintained for the services carried via the DRBs. QoS parameters like packet delay budget, packet loss rate, and throughput requirements can be defined for DRBs to meet the service-level agreements (SLAs) and user expectations.

A RLC sojourn time may include an amount of time that an RLC PDU spends in a queue, buffer, or buffer pool of the RLC layer. For example, an application may generate a data flow that comprises RLC PDUs associated with an LCH. The PDUs may be placed in a queue or buffer while waiting to be assigned to a data radio bearer (DRB) and transmitted to a destination device. An example of such a queue may include a DRB queue. The amount of time that an RLC PDU remains in the queue or buffer may be referred to as an RLC sojourn time.

A buffer or a buffer pool can include a queue, staging mechanism, or other pre-transmission framework for PDUs to be communicated. A buffer may include a size referring to the amount of data that may be stored in the buffer. The amount of time that data spends in a buffer, a QoS or other type of prioritization, and other characteristics of data stored in a buffer may be tracked. A buffer or buffer pool may correspond to a particular protocol layer. For example, an application buffer pool can refer to PDUs produced and temporarily stored at an application layer.

Jitter, as referred to herein, can include a variation in arrival times of packets or PDUs in a data flow. An example of jitter can include changes in RLC sojourn times. Jitter can be caused by a number of factors, including network congestion, routing changes, and hardware issues. Latency can include the time involved in a packet traveling from a source to a destination. Latency can be affected by one or more factors, such as a distance between the source and destination, a type of network being traversed, and an amount of traffic on the network. Jitter and latency can be a problem for applications that require real-time interaction, such as voice and video over IP (VOIP) and online gaming. A data flow can include the reception and transmission of packets or PDUs that are logically associated with a particular application or service.

A slice, a network slice, etc., can include a network architecture that enables the multiplexing of virtualized and independent logical networks to be implemented on the same physical network infrastructure. Each network slice can be an isolated, end-to-end network tailored to fulfill diverse requirements requested by a particular application. A slice can involve software-defined networking (SDN) and/or network function virtualization (NFV). Examples of a network slice may include a default slice, a low latency slice, and a consumer slice.

A default slice can include a network slice configured to support data flows associated with background functions or processes, such a applications or traffic for streaming, browsing the internet, “best effort” applications or traffic, etc. A low latency slice can include a network slice configured to support data flows corresponding to dedicated resources (e.g., a configured grant, a specified number of transmission/retransmissions, etc.). Examples of a low latency slice may include a network slice with characteristics or features appropriate for decreasing latency. For example, higher scheduling priority, pre-allocated resource grants, shorter scheduling request (SR) periodicities, etc. In some implementations, such features may not be in a consumer network slice that is configured for higher throughput and reliability but not low latency. A consumer slice can include a network slice configured to support data flows corresponding to an application (e.g., a mobile application executed by a UE). Examples of such data flows can include communication services (e.g., voice and video calls), gaming services, audio/video streaming services, and more. A consumer slice can include a network slice configured for low latency services; however, not all low latency slices are necessarily consumer slices and not all consumer slices are configured to need or require low latency.

Currently available technologies fail to provide any, or adequate, solutions for dynamically adapting processes and resources to different types of channels, data flows, applications, and services. For example, a single slice, bearer, and data flow can be configured for applications that have different traffic characteristics and key performance indicators (KPIs), such as data rate requirements, latency requirements, reliability requirements, and more. When a consumer slice is configured for a communication application or a gaming application, traffic for other low latency applications (e.g., associated with a low latency network slice) may be routed through the same consumer slice as well. This can result in wastage or non-use of dedicated resources assigned for low latency applications (e.g., configured grants, number of transmission repetitions, etc.). Additionally, high bandwidth applications (e.g., for communication applications, gaming applications, etc.) that end up having delayed or unresponsive data flows can block other low latency data flows. Furthermore, applications with different characteristics within a slice can cause buffering, resulting in an increase in jitter, latency, and other negative performance metrics for data flows of other applications.

One or more of the techniques described herein provide solutions for dynamically adapting processes and resources to different types of channels, data flows, applications, and services. These techniques may include determining the jitter of a LCH based on a corresponding RLC sojourn time, determining a data rate adaptation based on the jitter, and informing a corresponding application of the data rate adaptation. These techniques can also include determining and applying a prioritized bit rate for LCHs based on a corresponding jitter. These techniques can also include initiating different PDU sessions and/or LCHs for applications and services with different QoS and KPIs. These techniques can also include initiating different LCHs within a slice for applications with different QoS and KPIs.

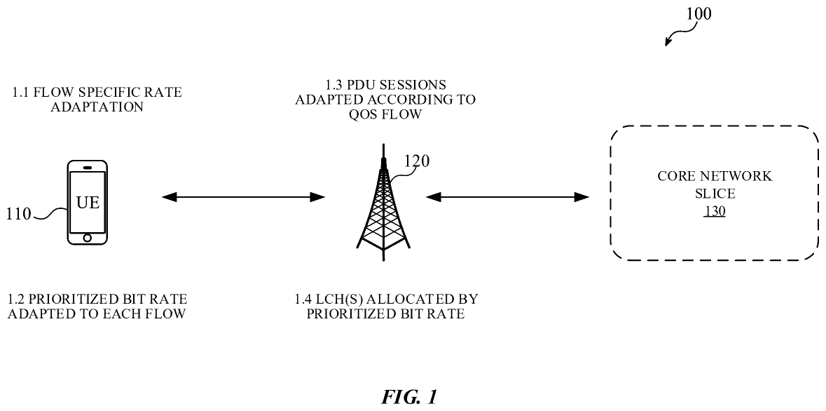

FIG. 1 is a diagram of an example of an overview 100 of dynamic adaptation according to data flow according to one or more implementations described herein. As shown, overview 100 can be implemented by UE 110, base station 120, and core network slice 130. In some implementations, dynamic adaptation may include UE 110 determining that PDUs of a LCH experience a RLC sojourn time greater than a threshold and adapting a bit rate of a corresponding application processor to address (e.g., reduce, remedy, correct, etc.) the RLC sojourn time (at 1.1). In some implementations, dynamic adaptation can include UE 110 determining that PDUs of a LCH experience a RLC sojourn time greater than a threshold and adapting prioritized bit rate (PBR) associated with a data flow of the PDUs to address (e.g., reduce, remedy, correct, etc.) the RLC sojourn time (at 1.2).

In some implementations, dynamic adaptation may include UE 110, base station 120, and core network slice 130 establishing PDU sessions configured for different QoS flows (e.g., QoS flows proscribing real-time data flows versus QoS flows proscribing something else than real-time data flows) (at 1.3). In some implementations, dynamic adaptation may include UE 110 and base station 120 establishing different LCHs for data flows having different PBRs (e.g., real-time data flows versus less than real-time data flows) (at 1.4). The LCHs can be associated with applications corresponding to different tiers, classes, or types of data flows. These and other features are described in additional detail with reference to remaining Figures.

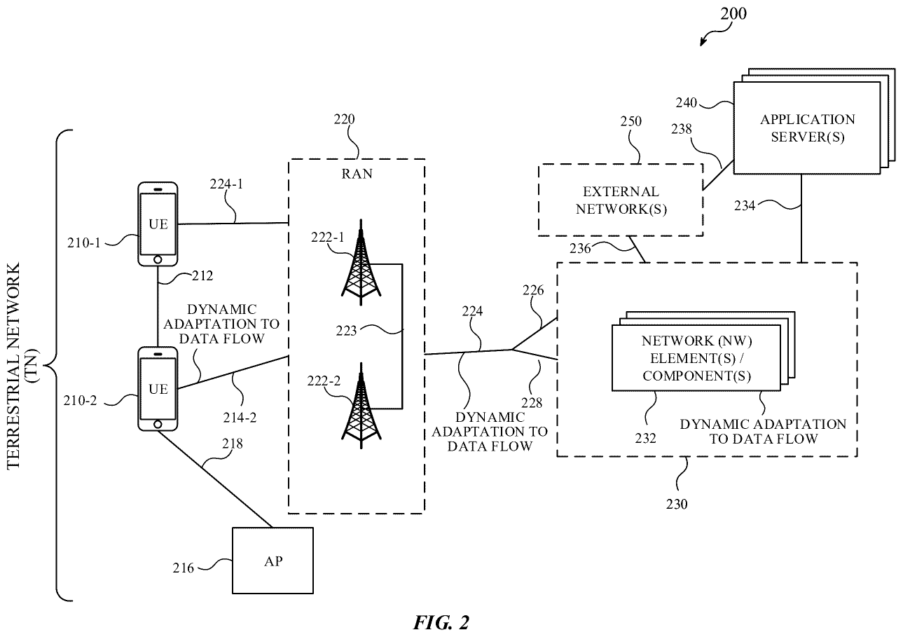

FIG. 2 is an example network 200 according to one or more implementations described herein. Example network 200 may include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210 may communicate with RAN node 222 to request SL resources. RAN node 222 may respond to the request by providing UE 210 with a dynamic grant (DG) or configured grant (CG) regarding SL resources. A DG may involve a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with (e.g., be communicatively coupled) RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

As described herein, UE 210 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 may operate using stand-alone unlicensed operation, licensed assisted access (LAA), eLAA, and/or feLAA mechanisms. In these implementations, UEs 210 and the RAN nodes 222 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) may be performed at any of the RAN nodes 222 based on channel quality information fed back from any of UEs 210. The downlink resource assignment information may be sent on the PDCCH used for (e.g., assigned to) each of UEs 210.

One or more of the techniques described herein can be implemented to dynamically adapting processes and resources to different types of channels, data flows, applications, and services. For example, baseband circuitry and/or UE 210 may determine a jitter of a LCH based on a corresponding RLC sojourn time, determining a data rate adaptation based on the jitter, and informing a corresponding application of the data rate adaptation. A bit rate adaptation may include a change in a bit rate associated with a data flow. Additionally, or alternatively, baseband circuitry and/or UE 210 can determine and apply a prioritized bit rate for LCHs based on a corresponding jitter. Furthermore, UE 210, base station 222, and/or core network 230 can initiate different PDU sessions and/or LCHs, within the same slice (e.g., a consumer slice), for applications with different QoS requirements and/or KPIs. These and other features are described in additional detail with reference to the Figures.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

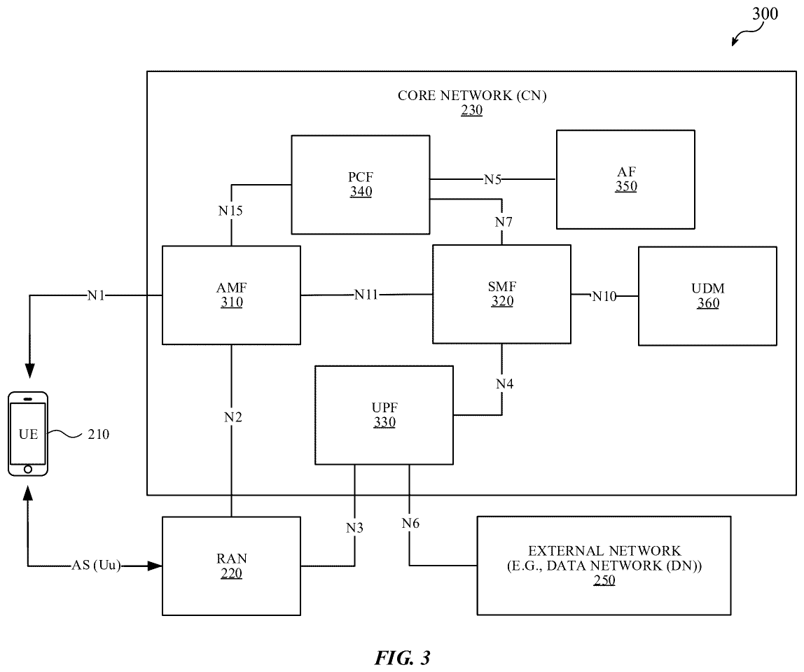

FIG. 3 is a diagram of an example network architecture 300 according to one or more implementations described herein. As shown, example network architecture 300 may include UE 210, RAN 220, CN 230, and external network 250. RAN 220 may include base station 222 and/or one or more other types of APs 216. CN 230 may include access and mobility management function (AMF) 310, session management function (SMF) 320, user plane function (UPF) 330), policy control function (PCF) 340, application function (AF) 350, and unified data management (UDM) node 360. AMF 310, SMF 320, UPF 330, PCF 340, AF 350, and UDM node 360 may be functions of CN 230 and may be implemented by one or more servers in a centralized or distributed networking environment, which may include one or more network virtualization functions (NVF). External network 250 may include a data network that includes one or more application servers, the Internet, another telecommunications network, and/or another type of network. In some implementations, example network architecture 300 may include one or more additional, alternative, and/or differently arranged functions, interfaces, or other features than those shown in FIG. 3.

AMF 310 may communicate with RAN 220 via an N2 interface and UE 210 via an N1 interface. AMF 310 may manage authentication, registration, and other functionalities relating to UEs 210 accessing a telecommunication mobile network. AMF 310 may manage handovers, paging, and other functionality regarding the mobility and communications of UEs 210. AMF 310 may also provide security functionality for authenticating and authorizing UEs 210. AMF 310 may communicate with SMF via an N11 interface, with PCF 340 via an N15 interface, and with UPF 340 via an N4 interface.

SMF 320 may provide PDU session management. To do so, SMF 320 may collect information related to managing a PDU session from various network components (e.g., UPF 330, PCF 340, AF 350, etc.) and control or orchestrate the network components based on a request from AMF 310. SMF 320 may be responsible for establishing, maintaining, and terminating user sessions in CN 230. SMF 320 may manage user plane (UP) resources and interact with UPF 330 to ensure that data packets are correctly routed and forwarded.

SMF 320 may receive PDU session establishment and/or session modification request from UE 210. The request may include an indication for assistance with a UL PDU set identification. The request may also indicate a real-time transport protocol (RTP) header extension and/or transport layer protocol corresponding to the requested assistance. SMF 320 may determine whether a protocol description, corresponding to the request, has been provided by PCF 340 and/or AF 350. The protocol description may include information about the RTP header extensions and/or other protocol features used by an application, and in turn, enable UE 210 to identify PDU sets from UL packets. The protocol description may also, or alternatively, include information about one or more other types of transport layer protocols and/or protocol features used by an application, such that UE 210 may identify PDU sets from UL packets based on how the application uses the transport layer protocol.

SMF 320 may include PDU set protocol descriptions, QoS profiles and parameters, quality flow identifiers (QFIs), and/or one or more additional or alternative types of information to, for example, enable UL PDU sets of a given application or service to be appropriately identified. For example, AF 350 may include protocol descriptions for different types of applications and services supported by the network, such as XR applications and/or XRM applications and services. The protocol descriptions may include information to enable UE 210, base stations 222, and other devices to identify PDU sets within a service data flow. SMF 320 may receive the protocol descriptions from AF 350 via PCF 340, and may provide the protocol descriptions to UE 210, RAN 220, UPF 330, and/or one or more of the devices or entities described herein. In some implementations, the protocol descriptions provided by SMF 320 may be based, at least in part, on rules received from PCF 340.

UPF 330 may communicate with RAN 220 via an N3 interface, PCF 340 via an N7 interface, and SMF 320 via an N11 interface, which may be routed through RAN 220. UPF 330 may operate as a point of connection for PDU sessions between RAN 220 and external data network 250 (e.g., the Internet, another telecommunication network, etc.) via interface N6. UPF 330 may also provide support for packet routing, forwarding, and inspection. UPF 330 may provide for user plane rule enforcement, QoS handling, UL/DL rate enforcement, and service data flow (SDF) to QoS flow mapping. UPF 330 may communicate with SMF 320 via an N4 interface and with RAN 220 via an N3 interface.

PCF 340 may provide policy control and flow-based control functionalities. PCF 340 may include and provide policy charging and control (PCC) rules for applications, data flows, PDU sets, gating, QoS, etc., to SMF 320. PCF 340 may also provide access and mobility management policies to AMF 310. PCF 340 may communicate with SMF 320 via an N7 interface and with AMF 310 via an N15 interface.

UE 210 may send and receive information from RAN 220 via an access stratum (AS) interface. UE 210 may also send and receive PDU set information (e.g., protocol descriptions for PDU set information) from SMF 320. QoS flow profiles and PDU set protocol descriptions may also be configured from SMF 320 to RAN 220 and UE 210. Each QoS flow profile and/or PDU set protocol description may be associated with a set of QoS parameters that may be part of a QoS profile stored by RAN 220 and updated by AMF 310. Examples of QOS parameters may include a resource type, packet delay budget (PDB), quality flow identifier (QFI), packet error rate (PER), averaging window, and more. AMF 310 may provide UE 210 with QoS rules during a PDU session via a non-access stratum (NAS) protocol or interface.

AF 350 may include a network function configured to manage traffic and QoS assignments, through interaction with the policy elements. AF 350 may expose an application layer for interaction with 5G network functions (NFs) and network resources. AF 350 may reside in a control plane of a 5G service-based architecture (SBA), and AF 350 may function to access a network repository function (NEF) for retrieving resources, interacting with PCF 340 via an N5 interface, enabling policy control, traffic routing for applications, and providing application services to subscribers.

UDM node 360 may manage subscription-related information to support the handling of communication sessions. UDM node 360 may store subscription data of UE 210, which may be communicated between the UDM node 360 and the AMF 310 via an N8 interface (not shown). UDM node 360 may communicate with SFM 320 via an N10 interface. UDM node 360 may include two parts, an application functional entity (FE) and a unified data repository (UDR). The UDR may store subscription data and policy data for UDM node 360 and PCF 340, and/or structured data for exposure and application data (including packet flow descriptions (PFDs) for application detection and requested information). UDM node 360 may include a UDM-FE, which may process credentials, perform location management, subscription management, and so on. The UDM-FE may also access subscription information stored in the UDR and perform authentication credential processing, user identification handling, access authorization, registration/mobility management, and subscription management.

Network architecture 300 may implement network slicing to enhance the performance of network functions and procedures. For example, network slicing may leverage software-defined networking (SDN) techniques, network function virtualization (NFV) techniques, etc., to use the physical network infrastructure (e.g., physical components of UE 210, RAN 220, etc.) to create multiple, virtual instances of a network scenario corresponding to a target network procedure and causing each network slice to perform different portions of the network procedure (e.g., multiplexing), such that optimized performance of the procedure is achieved as results from each portion are combined or otherwise processed (e.g., demultiplexed) amounting to the completion of the procedure as a whole. Accordingly, in some scenarios, network slicing may include a network architecture and technique that may enable device and/or network performance enhancement or optimization by using the physical infrastructure resources to create multiple, logical instances of a given network scenario, and causing different portions of a network process, function, or procedure to be performed by the different instance of the network scenario.

Each network slice may be an independent, end-to-end 5G network (which may be logical or physical). Each network slice may span across multiple or all network functions and may be isolated from other slices. Several of the components and functions of FIG. 3 may have specific behaviors related to network slice configuration. For example, UDM 360 may store a subscription for a user (e.g., of UE 210), for example, whether the user has purchased a subscription to a high-definition (HD) streaming slice. PCF 340 may provide rules to UE 210 to identify which traffic to send via which slice. AMF 310 may function as a single point of contact of UE 210 for slice-related configurations. UE 210 may set up slice-specific sessions, and route packets on the appropriate slice(s). The independence of network slices can allow for customization of RAN 220 and/or CN 230 configurations per network slice. From an AS perspective, slice traffic can be part of a separate DRB. From a NAS perspective, slice traffic can be part of separate PDU sessions.

Network architecture 300 can implement network slice selection assistance information (NSSAI) and single NSSAI (S-NSSAI) to enable efficient and dynamic network slicing. NSSAI can include a set of parameters used to identify and describe a network slice. Examples of these parameters can include a slice differentiator (SD) that can be a globally unique identifier and a slice service type (SST) that can indicate a specific service or application type associated with a network slice.

S-NSSAI can be an extension of NSSAI, specifically designed to support single network slice selection. S-NSSAI can provide additional information to assist UE 210 and the network in selecting the most suitable network slice based on the context and requirements of the communication session. S-NSSAI can involve one or more NSSAIs, each containing an SD and SST pair. Multiple NSSAIs can be included to represent a set of available network slices or to provide fallback options if the primary slice is not available. When UE 210 initiates a connection with a 5G network, UE 210 can include S-NSSAI information in the initial signaling message (e.g., registration request). The S-NSSAI can reflect desired network slice preferences. The network can match the S-NSSAI with an available network slice instance and selects the most appropriate slice that satisfies one or more corresponding requirements. The selection process can consider one or more factors, such as network resources, QoS policies, and network conditions. S-NSSAI can also be involved in dynamically switching between network slices.

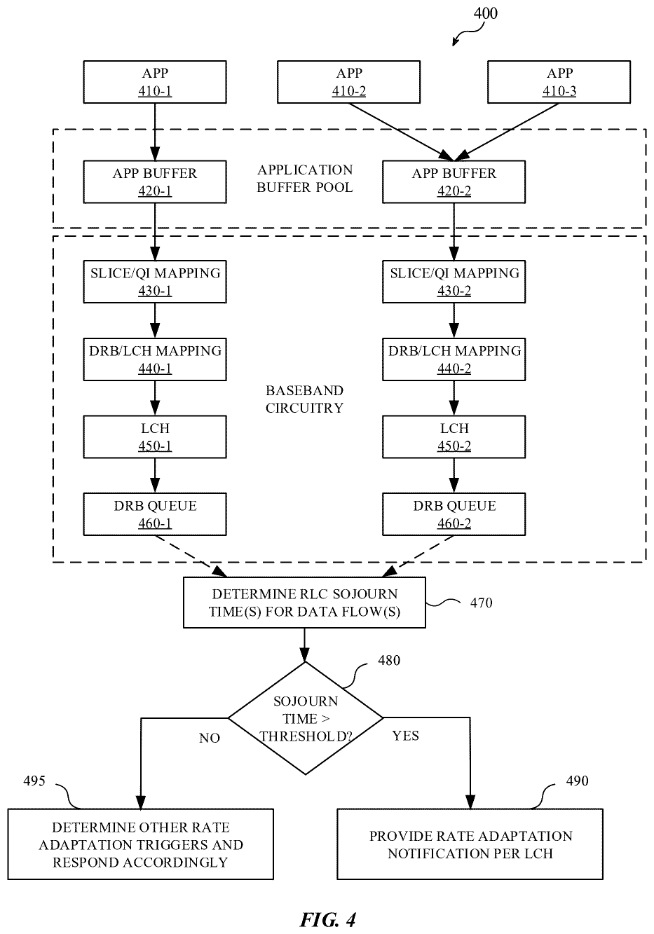

FIG. 4 is a diagram of an example 400 of flow-specific rate adaptation according to one or more implementations described herein. As shown, example 400 one or more features and operations, such as application processors 410-1, 410-2, and 410-3, application buffers 420-1 and 420-2, slice/QI mapping 430-1 and 430-2, DRB/LCH mapping 440-1 and 440-2, LCH 450-1 and 450-2, and DRB queue 460-1 and 460-2. Example 400 also include operations for determining RLC sojourn times for PDUs (block 470), determining whether an RLC sojourn time is greater than a corresponding threshold (block 480), providing rate adaptation notifications per LCH (block 495), and determining other rate adaption triggers and responding accordingly (block 490). Similarly numbered entities, such as application processors 410-1, 410-2, and 410-3, application buffers 420-1 and 420-2, etc., may be referred to collectively as applications 410, application buffers 420, and so on.

Example 400 may be implemented by UE 210. In some implementations, some or all of process 300 may be performed by one or more other systems or devices, including one or more of the devices of FIGS. 2-3. Additionally, example 400 may include one or more fewer, additional, differently ordered and/or arranged features or operations than those shown in FIG. 4. In some implementations, some or all of the operations of example 400 may be performed independently, successively, simultaneously, etc., of one or more of the other operations of example 400. As such, the techniques described herein are not limited to a number, sequence, arrangement, timing, etc., of the features, operations, and/or processes depicted in FIG. 4.

Application processors 410 can be executing software applications, operating system features, or another types of software. An application processor can be a central processing unit (CPU), a general purpose processor, and the like. Application processors 410 can each generate a data flow corresponding to a PDU session to be communicated to a destination system or device via base station 222, CN 230, DN 250, etc. The data flow may be associated with a QoS, Qos identifier (QI), one or more KPIs, etc.

As shown, the data flow of application processor 410-1 may be temporarily stored in application buffer 430-1, while the data streams for application processors 410-2 and 410-2 can be temporarily stored in application buffer 430-2. Application processors 410 cans use different application buffers 420 for one or more reasons, such as a difference in the types of applications being executed, a difference in the time-sensitivities or priorities of the data flow, a difference in the QoS associated with the data flows, and more.

Application buffers 430 may include memory or storage allocated for temporarily storing data flows from applications. Application buffers 420 can be implemented as a cache memory of processors executing applications processor 410, or another type of temporary memory accessible to a processor executing application processors 410. Applications buffers 430-1 and 430-2 can have the same storage capabilities and parameters or different storage capabilities or parameters. Applications buffers 430-1 and 430-2 may be part of one or more groups of application buffers 420 arranged or allocated within an application buffer pool of UE 210.

Baseband circuitry may receive the data flows from application buffers 420 and can map the data flows to a network slice based on a QoS (or QI) of each data flow (at 430-1 and 430-2). For example, UE 210 may be aware of different network slices configured to manage data flows of different QoS. Baseband circuitry may map data flows received from applications 410 to network slices suitable for the QoS of the data flow. As a data flow of application processor 410-1 may have a different QoS than data flows of application processors 410-2 and 410-3, the data flow of application processor 410-1 may be associated with a different network slice than the data flows of application processors 410-2 and 410-2. The baseband circuitry can also map each data flow with a DRB and/or LCH (at 440-1 and 440-2). The data flows can be mapped to DRBs and/or LCH based on a network slice and/or QoS associated with the data flows. As such, the data flow of application processor 410-1 can be mapped to a different DRB and/or LCH than the data flows of application processors 410-2 and 410-3.

Data flows of different LCHs 450 may be temporarily stored in DRB queues 460. As the data flows may originate from different types of applications, have different QoS indicators, be associated with different network slices, LCHs, and/or DRBs, the size of a DRB queue, a configuration of a DRB queue, and an amount of time a data flow may spend in a DRB queue may vary. A DRB queue may be implemented as a cache memory of a baseband circuitry processing a data flow of a logical channel, or another type of temporary memory accessible to a baseband circuitry processing a data flow of a logical channel. DRB queues 460-1 and 460-2 can have the same storage capabilities and parameters or different storage capabilities or parameters. Applications buffers 430-1 and 430-2 may be part of one or more groups of DRB queues arranged or allocated within a memory coupled to a baseband processor or circuitry.

Example 470 can continue with operations 470-495. In some implementations, operations 470-495 can be executed or performed by baseband circuitry or a baseband processor. In some implementations, one or more of operations 470-495, including a portion of any of operations 470-495, may be performed, facilitated, or enabled by one or more other components of UE 210. As shown, example 400 may include determining an RLC sojourn time for data flows (block 470). For example, baseband circuitry may determine how long a data flow has spent in a DRB queue 460-1 or 460-2. In some implementations, baseband circuitry can determine how much time has transpired since the data flow left an application and a left (or arrived at) a DRB queue 420. In some implementations, baseband circuitry may calculate or determine a sojourn time based on other data flow events. RLC sojourn time may be determined on a per-LCH basis. As such, the RLC sojourn time for the data flow of application processor 410-1 may be based on LCH 450-1, and the RLC sojourn time for both of the data flows of application processors 410-2 and 410-3 may be based on LCH 450-2 since the data flows of application processors 410-2 and 410-3 share the same LCH.

Baseband circuitry may determine whether the RLC sojourn time is greater than a corresponding threshold (block 480). The corresponding threshold may be a RLC sojourn time threshold. In some implementations, the baseband circuitry may determine a jitter based on differences between the RLC sojourn times of PDUs and/or may determine whether the jitter is greater than a jitter threshold. In some implementations, different types of data flows may have different RLC sojourn times and/or different RLC sojourn time thresholds. For example, an RLC threshold may be based on an application type, a data flow priority, a QoS, etc. When the RLC sojourn time is greater than the threshold, baseband circuitry or UE 210 may proceed by providing a bit rate adaptation notification per LCH (block 490). For example, when the RLC sojourn time for a data flow is greater than a corresponding RLC sojourn time threshold, baseband circuitry may generate a message or signal to an application (e.g., an application processor) associated with a data flow of a corresponding LCH about the RLC sojourn time for the LCH being greater than the threshold.

Bit rate adaptations can be indicated to application processors 410 individually (e.g., based on a LCH associated with a data flow of a particular application processor). As such, while data flows from application processors 410-2 and 410-3 may correspond to PDUs in the same DRB queue 460-2, a bit rate adaptation can be determined for individual data flows and selectively communicated to the corresponding application processor. For example, the baseband circuitry can determine RLC sojourn times for each data flow, can determine an appropriate (e.g., different) bit rate adaptation for each data flow, and can selectively notify application processors 410-2 and 410-3 of the bit rate adaptations.

In some implementations, this notification may cause or enable the application to reduce the rate at which the application is generating the data flow. For example, when an RLC sojourn time for LCH 450-1 exceeds the threshold, baseband circuitry may notify application processor 410-1. Similarly, when an RLC sojourn time for LCH 450-2 exceeds the threshold, baseband circuitry may notify both application processors 410-2 and 410-3, since the data flows for application processors 410-2 and 410-3 are each associated with LCH 450-2. By contrast, when the RLC sojourn time is less than the threshold, baseband circuitry or UE 210 may proceed by: 1) deterring other rate adaptation triggers; and 2) responding accordingly (at 495). Examples of other rate adaptation triggers may include rate adaptation triggers based on queue threshold, how soon data is being flushed out from the queue, radio conditions, stalls, etc. Examples of responding to such triggers may include UE 210 increasing or decreasing the bitrate and/or change a resolution or codec based on queue thresholds, when data is not moving out of the queue or stalls detected, or the device is reporting poor radio quality metrics. As such, one or more of the techniques, described herein, may provide solutions for dynamic adaptation through flow-specific rate adaptation.

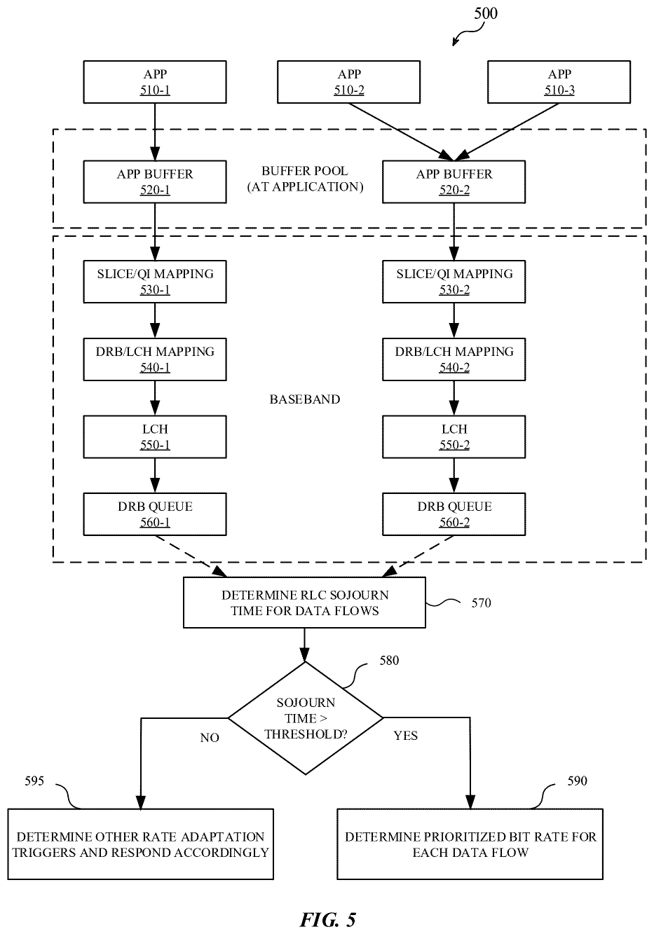

FIG. 5 is a diagram of an example 500 of flow-specific rate adaptation according to one or more implementations described herein. As shown, example 500 one or more features and operations, such as application processors 510-1, 510-2, and 510-3, application buffers 520-1 and 520-2, slice/QI mapping 530-1 and 530-2, DRB/LCH mapping 540-1 and 540-2, LCH 550-1 and 550-2, and DRB queue 560-1 and 560-2. Example 500 also include operations for determining an RLC sojourn times for data flows (block 570), determining whether an RLC sojourn time is greater than a corresponding threshold (block 580), providing rate adaptation notifications per LCH (block 595), and determining other rate adaption triggers and responding accordingly (block 590). Similarly numbered entities, such as application processors 510-1, 510-2, and 510-3, application buffers 520-1 and 520-2, etc., may be referred to collectively as application processors 510, application buffers 520, and so on.

Example 500 may be implemented by UE 210. In some implementations, some or all of process 300 may be performed by one or more other systems or devices, including one or more of the devices of FIGS. 2-3. Additionally, example 500 may include one or more fewer, additional, differently ordered and/or arranged features or operations than those shown in FIG. 5. In some implementations, some or all of the operations of example 500 may be performed independently, successively, simultaneously, etc., of one or more of the other operations of example 500. As such, the techniques described herein are not limited to a number, sequence, arrangement, timing, etc., of the features, operations, and/or processes depicted in FIG. 5.

Application processors 510 can execute software applications, operating system features, or another types of software. Application processors 510 may each generate a data flow corresponding to a PDU sessions with PDUs to communicated to a destination system or device via base station 222, CN 230, DN 250, etc. The data flow may be associated with a QoS, QoS identifier (QI), one or more KPIs, etc.

As shown, the data flow of application processor 510-1 may be temporarily stored in application buffer 530-1, while the data streams for application processors 510-2 and 510-2 can be temporarily stored in application buffer 530-2. Application processors 510 may use different application buffers 520 for one or more reasons, such as a difference in the types of applications being executed, a difference in the time-sensitivities or priorities of the data flow, a difference in the QoS (QOS identifier, QoS parameters, etc.) associated with the data flows, and more.

Application buffers 530 may include memory or storage allocated for temporarily storing data flows from applications. Application buffers 520 can be implemented as a cache memory of processors executing application processors 510, or another type of temporary memory accessible to a processor executing application processors 510. Applications buffers 530-1 and 530-2 can have the same storage capabilities and parameters or different storage capabilities or parameters. Applications buffers 530-1 and 530-2 may be part of one or more groups of application buffers 520 arranged or allocated within an application buffer pool of UE 210.

Baseband circuitry may receive the data flows from application buffers 520 and can map the data flows to a network slice based on a QoS (or QI) of each data flow (at 530-1 and 530-2). For example, UE 210 may be aware of different network slices configured to manage data flows of different QoS. Baseband circuitry may map data flows received from application processors 510 to network slices suitable for the QoS of the data flow. As a data flow of application processor 510-1 may have a different QoS than data flows of application processors 510-2 and 510-3, the data flow of application processor 510-1 may be associated with a different network slice than the data flows of application processors 510-2 and 510-2. The baseband circuitry can also map each data flow with a DRB and/or LCH (at 540-1 and 540-2). The data flows can be mapped to DRBs and/or LCH based on a network slice and/or QoS associated with the data flows. As such, the data flow of application processor 510-1 can be mapped to a different DRB and/or LCH than the data flows of application processors 510-2 and 510-3.

Data flows of different LCHs 550 may be temporarily stored in DRB queues 560. As the data flows may originate from different types of applications, have different QoS indicators, be associated with different network slices, LCHs, and/or DRBs, the size of a DRB queue, a configuration of a DRB queue, and an amount of time a data flow may spend in a DRB queue may vary. A DRB queue may be implemented as a cache memory of a baseband circuitry processing a data flow of a logical channel, or another type of temporary memory accessible to a baseband circuitry processing a data flow of a logical channel. DRB queues 560-1 and 560-2 can have the same storage capabilities and parameters or different storage capabilities or parameters. Applications buffers 530-1 and 530-2 may be part of one or more groups of DRB queues arranged or allocated within a memory coupled to a baseband processor or circuitry.

Example 570 can continue with operations 570-595. In some implementations, operations 570-595 can be executed or performed by baseband circuitry or a baseband processor. In some implementations, one or more of operations 570-595, including a portion of any of operations 570-595, may be performed, facilitated, or enabled by one or more other components of UE 210. As shown, example 500 may include determining an RLC sojourn time for data flows (block 570). For example, baseband circuitry may determine how long a data flow has spent in a DRB queue 560-1 or 560-2. In some implementations, baseband circuitry can determine how much time has transpired since the data flow left an application and a left (or arrived at) a DRB queue 520. In some implementations, baseband circuitry may calculate or determine a sojourn time based on other data flow events. RLC sojourn time may be determined on a per-LCH basis. As such, the RLC sojourn time for the data flow of application processor 510-1 may be based on LCH 550-1, and the RLC sojourn time for both of the data flows of application processors 510-2 and 510-3 may be based on LCH 550-2 since the data flows of application processors 510-2 and 510-3 share the same LCH.

Baseband circuitry may determine whether the RLC sojourn time is greater than a corresponding threshold (block 580). The corresponding threshold may be a RLC sojourn time threshold. In some implementations, different types of data flows may have different RLC sojourn times and/or different RLC sojourn time thresholds. For example, an RLC threshold may be based on an application type, a data flow priority, a QoS, etc. When the RLC sojourn time is greater than the threshold, baseband circuitry or UE 210 may proceed by determining a prioritized bit rate (PBR) for the corresponding data flow (block 590).

A PBR can include a fixed PBR or a flexible PBR. A fixed PBR can include a predetermined bit rate associated with different levels of priority. Data traffic with a higher priority can receive a larger portion of available bandwidth, while lower priority traffic can receive a smaller portion of available bandwidth. Fixed PBR can be used for applications where certain traffic types require a constant bandwidth allocation. By contrast a flexible PRB can include a PRB that can dynamically adjust based on real-time network conditions. Flexible PRB can enable network resources to be used with greater efficiency by allocating additional bandwidth to high-priority traffic during periods of congestion. Flexible PBR is suitable for networks with varying traffic demands.

Accordingly, a change the PBR associated with a data flow can increase or decrease an RLC sojourn time PDUs of the data flow. Increasing a PBR associated with a data flow can decrease the RLC sojourn time experienced by PDUs of the data flow as additional DRBs or bandwidth may be allocated to the PDUs over the PDUs of another data flow. By contrast, decreasing a PBR associated with a data flow can increase the RLC sojourn time experienced by PDUs of the data flow as bandwidth (e.g., DRBs) can be allocated to the PDUs of another data flow before the PDUs of the data flow with a reduced PBR.

When the RLC sojourn time for a data flow is greater than a corresponding RLC sojourn time threshold, baseband circuitry may determine a new or updated PRB for a data flow associated with a corresponding LCH. The change in PRB can be determined based on the amount of time of the RLC sojourn time threshold or a difference between the RLC sojourn time and the RLC sojourn time threshold. Baseband circuitry may determine the new or updated bit rate on a per data flow or a per LCH basis.

While not shown, baseband circuitry may generate a message or notification of the new or updated PBR and can communicate the notification to the application processor of a corresponding LCH. In some implementations, this notification may cause or enable the application to increase or decrease the rate at which the application is generating the data flow. Alternatively, the notification may cause or enable the application to associate the data flow with a different level of priority or QoS.

The PRB can be indicated to application processors 410 individually (e.g., based on a LCH associated with a data flow of a particular application processor). As such, while data flows from application processors 410-2 and 410-3 may correspond to PDUs in the same DRB queue 460-2, an updated PRB can be determined for individual data flows and selectively communicated to the corresponding application processor. For example, the baseband circuitry can determine RLC sojourn times for each data flow, can determine an appropriate (e.g., different) PRB for each data flow, and can selectively notify application processors 410-2 and 410-3 of the new PRB.

For example, when an RLC sojourn time for LCH 550-1 exceeds the threshold, baseband circuitry may notify application processor 510-1. Similarly, when an RLC sojourn time for PDUs of LCH 550-2 exceed the RLC sojourn time threshold, baseband circuitry may notify application processor 510-2 of an updated PRB (without notifying application processor 510-3). Notifying an application processor of a new or updated PRB can cause the application processor to include or indicate the new PRB in PDUs of the data flow. In turn, the PDUs with the new PRB can be managed differently by, for example, increasing or decreasing a priority with which the PDUs are matched to bandwidth or DRB resources.

By contrast, when the RLC sojourn time is less than the threshold, baseband circuitry or UE 210 may proceed by: 1) determining other rate adaptation triggers; and 2) responding accordingly (at 595). Examples of other rate adaptation triggers may include rate adaptation triggers based on queue threshold, how soon data is being flushed out from the queue, radio conditions, stalls, etc. Examples of responding to such triggers may include UE 210 increasing or decreasing the bitrate and/or change a resolution or codec based on queue thresholds, when data is not moving out of the queue or stalls detected, or the device is reporting poor radio quality metrics. As such, one or more of the techniques, described herein, may provide solutions for dynamic adaptation by changing the PBRs associated with different data flows and LCHs.

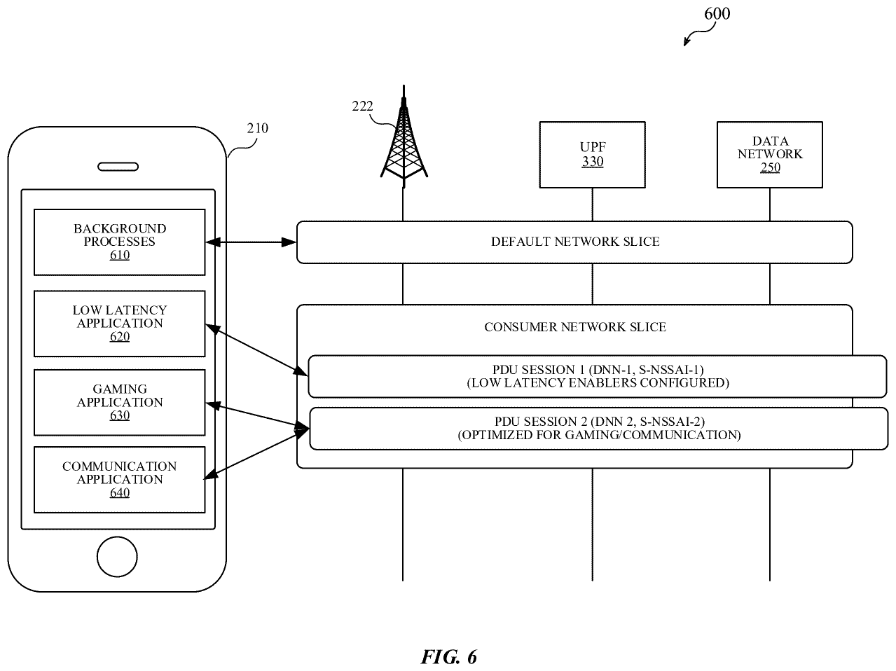

FIG. 6 is a diagram of an example 600 of dynamic adaptation by mapping data flows to multiple PDU sessions of a single network slice according to one or more implementations described herein. As shown, example 600 can be implemented by UE 210, base station 222, UPF 330, and data network 250. In some implementations, example 600 can be implemented by fewer, additional, and/or alternative devices or functions, such as one or more of those described in FIGS. 2-3. UE 210 can be configured to execute one or more types of processes and/or applications, such as background processes 610, low latency applications 620, gaming applications 630, and communication applications 640. The applications of FIG. 6 are non-limiting examples of processes and/or applications that can be executed by UE 210. In some implementations, UE 210 can implement one or more of the techniques described herein while executing fewer, additional, and/or alternative processes and applications.

The devices or entities of example 600 can operate to create a default network slice, a consumer network slice, and one or more other types of network slices. A network slice may be created in response to UE 210 initiating a corresponding process or application. The processes and applications executed by UE 210 can generate data flows that are communicated to a network slice. The processes and applications, and corresponding data flows, can be executed using one or more components of UE 210, such as an application processor, baseband circuitry, one or more types of memory, etc. The default network slice can be used for data flows of background processes 610. The consumer network slice can be used for data flows of low latency application 620, gaming application 630, and communication application 640 can be associated with a particular type of application, such as a consumer application.

UE 210, base station 222, UPF 330, and data network 250 can be configured to create multiple PDU sessions for the data flows of different types of applications within the same network slice. For example, PDN session 1 can be created for a data flow of low latency application 620. PDN session 1 can include, or be configured with, low latency enablers, such as a configured grant (CG), low latency, low loss, scalable throughput (LAS), physical uplink shared channel (PUSCH) repetitions, etc. By contrast, PDN session 2 can be optimized for consumer applications, such as gaming application 630 and communication application 640. Optimizing a PDN session for such applications may include latency features not be mapped to a PDU session for communication application. Additionally, optimizing a PDN session may be performed by providing features more appropriate for specific applications (e.g., by prioritizing higher throughput and reliability over of minimizing or eliminating latency). This would include higher scheduling weights, RLC AM mode, repetitions or aggregation being supported.

Each PDU session may be associated with a data network name (DNN) and/or an S-NSSAI. The DNN can be the same for each PDU session and the S-NSSAI can be different for each PDU. For example, PDU session 1 may be associated with DNN-1 and S-NSSAI-1, and PDN session 2 may be associated with DNN-1 and S-NSSAI-2. The DNN can comprise of a DNN associated with the consumer network slice. For example, the DNN can be used to identify the network slice establishing the different PDU sessions. The S-NSSAIs can be used to identify and manage the PDU sessions within the network slice. For example, the S-NSSAIs can be used to allocate and apply resources (e.g., a CG, LAS, PUSCH repetitions, etc.) to a data flow of one PDU session instead of the data flow of another PDU session. In some implementations, the DNN can be different for each PDU session.

Upon initiating an application, UE 210 can be configured to determine a whether the corresponds to one or more types or categories of applications or services. An example of a type or category of application (e.g., low latency application 620) may include applications that require, prefer, or otherwise correspond to data flows having greater real-time interactive services and/or a relatively high degree of jitter and/or latency sensitivity. Another example of a type or category of application may include applications (e.g., gaming application 630 and communication application 640) that require, prefer, or otherwise correspond to data flows having lesser or no real-time interactive services and/or a relatively low degree of jitter and/or latency sensitivity. This may be determined based on one or more parameters associated with the application performing appropriately and/or as designed and intended (e.g., based on an application type, a QoS, QI, amount of jitter, amount of latency, etc. An example of low latency application 620 may include an application that prefers or requires single digit latency to operate properly. An example of gaming application 630 and communication application 640 can include an application that can operate properly with a double or triple digit latency.

Upon initiating low latency application 620, UE 210 can map low latency application 620 to DNN-1 and/or S-NSSAI-1. UE 210 can send a PDU session establishment message or request to base station 222. Base station 222 can receive the PDU session establishment message or request and can send the PDU session establishment message or request to AMF 310 (not sown). AMF 310 can coordinate with base station 222 and one or more core network functions (e.g., UPF 330) to set up PDU session 1. Base station 222 may activate one or more low latency enablers (e.g., a CG, LAS, PUSCH repetitions, etc.) for PDU session 1 via RRC/DCI signaling.

Upon initiating low latency application 620, UE 210 can map low latency application 620 to DNN-1 and/or S-NSSAI-1. UE 210 can send a PDU session establishment message or request to base station 222. The message or request may include DNN-1 and/or S-NSSAI-1. Base station 222 can receive the PDU session establishment message or request and can send the PDU session establishment message or request to AMF 310 (not sown). AMF 310 can coordinate with base station 222 and one or more core network functions (e.g., UPF 330) to set up PDU session 1 for low latency application 620. Base station 222 may activate one or more low latency enablers (e.g., a CG, LAS, PUSCH repetitions, etc.) for PDU session 1 via RRC/DCI signaling. UE 210 can use the low latency enablers and PDU session 1, of the consumer slice, for data flows corresponding to low latency application 620.

Upon initiating gaming application 630 and/or communication application 640, UE 210 can map the application to DNN-2 and/or S-NSSAI-2. This may be based on an application name, application type, QoS parameter, QI, application priority, etc., associated with gaming application 630 and/or communication application 640. UE 210 can send a PDU session establishment message or request to base station 222. The message or request may include DNN-2 and/or S-NSSAI-2. Base station 222 can receive the PDU session establishment message or request and can send the PDU session establishment message to AMF 310 (not sown). AMF 310 can coordinate with base station 222 and one or more core network functions (e.g., UPF 330) to set up PDU session 2. Base station 222 may not activate the low latency enablers (e.g., a CG, LAS, PUSCH repetitions, etc.) for PDU session 2 used for PDU session 1. Instead, UE 210 may be configured with enablers consistent with the consumer network slice. UE 210 can use PDU session 2, of the consumer slice, for data flows corresponding to gaming application 630 and/or communication application 640. An enabler, as described herein, can be specific to high throughput and reliability such as slicing parameters, scheduling weights, repetitions, etc., whereas latency enablers, as described herein, can include configured grants, higher scheduling priorities, prescheduling, LAS, etc.

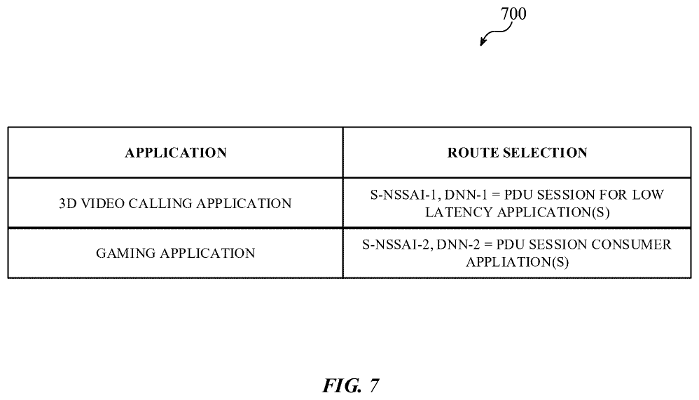

FIG. 7 is a diagram of an example data structure 700 for mapping data flows to PDU sessions according to one or more implementations described herein. As shown, example data structure 700 can include a table that includes an application column and a route selection column. The application column may include a name, type, category, or other indicating information associated with an application.

The route selection column may include information identifying a PDU session associated with an application indicated by the application column. As a non-limiting example, 3D video calling applications can be associated with S-NSSAI-1 and DNN-1, which can correspond to a PDU session for low latency applications. By contrast, gaming applications can be associated with S-NSSAI-2 and DNN-2, which can correspond to a PDU session for consumer applications (e.g., a gaming application, a communication application, etc.). Example data structure 700 may be used by UE 210 to map an application to a S-NSSAI-1 and DNN-1 upon initiating the application and sending a PDU session establishment message or request to base station 222.

Additionally, data structure 700 can be implemented using fewer, additional, and/or alternative information and/or arrangement of information than shown in FIG. 7. For example, in some implementations, the application column may include a performance attribute, or a range of values of a performance attribute, of an application (e.g., a QoS, QI, etc.). UE 210 can determine the S-NSSAI and/or DNN associated with the QoS, cause a corresponding PDU session to be a consumer slice, and route a data flow generated by the application to the PDU session. The PDU session may be associated with the S-NSSAI and/or DNN.

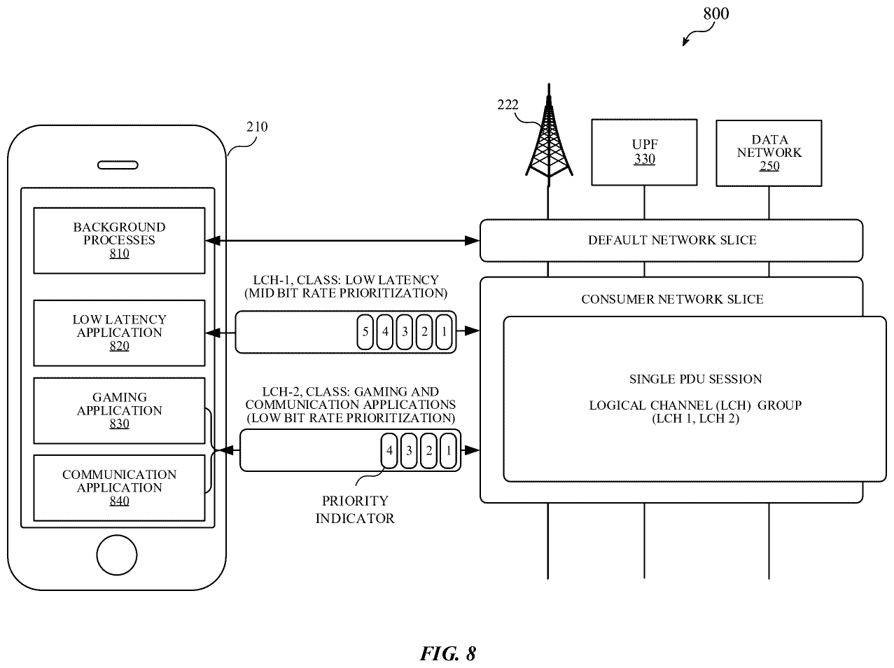

FIG. 8 is a diagram of an example 800 of dynamic adaptation by mapping LCHs of data flows to a single PDU session of a single network slice according to one or more implementations described herein. As shown, example 800 can be implemented by UE 210, base station 222, UPF 330, and data network 250. In some implementations, example 800 can be implemented by fewer, additional, and/or alternative devices or functions, such as one or more of those described in FIGS. 2-3. UE 210 can be configured to execute one or more types of processes and/or applications, such as background processes 810, low latency applications 820, gaming applications 830, and communication applications 840. The applications of FIG. 8 are non-limiting examples of processes and/or applications that can be executed by UE 210. In some implementations, UE 210 can implement one or more of the techniques described herein while executing fewer, additional, and/or alternative processes and applications.

The devices or entities of example 600 can operate to create a default network slice, a consumer network slice, and one or more other types of network slices (not shown). A network slice may be created in response to UE 210 initiating a corresponding process or application. The processes and applications executed by UE 210 can generate data flows that are communicated to a network slice. The processes and applications, and corresponding data flows, can be executed using one or more components of UE 210, such as an application processor, baseband circuitry, one or more types of memory, etc.

The default network slice can be used for data flows of background processes 610. The consumer network slice can be used for data flows of low latency application 620, gaming application 630, and communication application 640 can be associated with a particular type of application, such as a consumer application. Low latency application 820 can include an application that provides a service that requires, prefers, or is configured to operate, relative to other applications, in real-time data flow conditions with a low latency (e.g., single digit latency measured in milliseconds), little or no jitter, low packet loss rates, etc. Examples of other applications may include gaming applications, communication or messaging applications, and other types of consumer applications that may operate properly or adequately under more generous time and resource constraints.

UE 210 can be configured to communicate data flows for different applications using different LCHs in a single PDU session of one consumer slice. The applications may vary in terms of QoS and/or one or more other types of data flow parameters (e.g., latency, jitter, throughput rate, packet loss rate, etc.). For example, a data flow for low latency application 820 can be communicated using one LCH, and the data flows from gaming application and communication application 830 and 840 can be communicated using another LCH, while both LCHs correspond to the same PDU session and commercial network slice.

When UE 210 initiates low level application 820, UE 210 can determine a channel class or type for low level application 820 based on a QoS, latency, jitter, and/or other type of data flow or performance parameter associated with low level application 820. In some implementations, the parameter can be a bit rate associated with low level application 820. For purpose of explaining FIG. 8, assume that UE 210 determines that an appropriate channel class for low level application 820 is a LCH with a medium level bit rate prioritization or a prioritized bit rate that is a mid-tier bit rate (e.g., LCH-1). UE 210 can map LCH-1 to low level application 820 and send base station 222 a PDU session establishment message or request to base station 222. Base station 222 can send the PDU session establishment message or request to AMF 310 (not shown). AMF 310 can coordinate with base station 222 and one or more core network functions (e.g., UPF 330) to set up a PDU session in a consumer network slice, such that the PDU session and LCH-1 can be logically associated with one another. Base station 222 can configure and/or activate one or more low latency features or enablers (e.g., CG, LAS, PUSCH repetitions, etc.) for LCH-1, and since LCH-1 can be mapped to low latency application 820, the low latency features or enablers can be applied to the data flow of low latency application 820 as opposed to data flows of other applications (e.g., gaming application 830 and communication application 840).

As such, when UE 210 initiates a consumer application (e.g., gaming application 830 or communication application 840, UE 210 can determine a channel class or type for the consumer application based on an application type, a QoS, latency, jitter, and/or other type of parameter associated with consumer application. For purpose of explaining FIG. 8, assume that UE 210 determines that an appropriate channel class for the consumer application is a LCH with a low level bit rate prioritization or a prioritized bit rate that is a lower-tier bit rate (e.g., LCH-2). UE 210 can map LCH-2 to the consumer application. The medium bit rate prioritization of LCH-1 relative to the bit rate prioritization can be represented in FIG. 8 as LCH-1 having 5 priority indicators relative to the 4 priority indicators of LCH-2.

UE 210 can communicate information via LCH-2 using the same PDU session and consumer network slice as LCH-1. As low latency features or enablers (e.g., CG, LAS, PUSCH repetitions, etc.) are reconfigured, enabled, and disabled between UE 210 and base station 222, the low latency features or enablers can be mapped and applied to the LCH associated with the highest LCH type, LCH class, or the highest prioritized bit rate. In the example of FIG. 8, the low latency features or enablers can be mapped and applied to LCH-1, instead of LCH-2, since LCH-1 is associated with a higher prioritized bit rate and LCH class than LCH-2. In other words, UE 210 can apply the low latency features or enablers to the data stream of low latency application 820, instead of the data streams of the commercial applications, gaming application 830 and communication application 840.

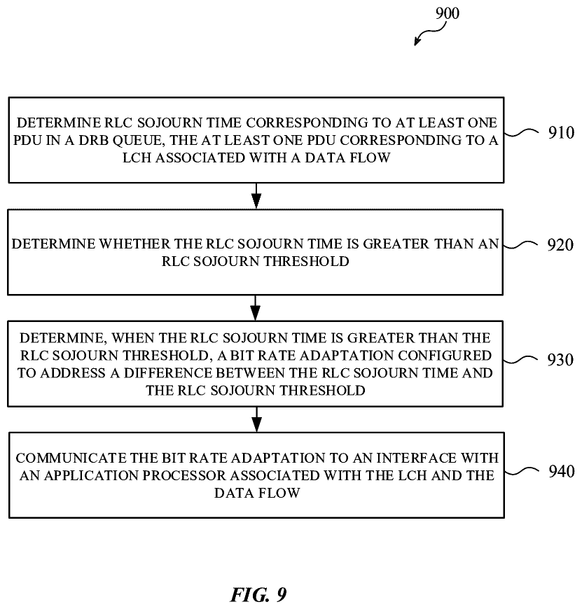

FIGS. 9-11 are diagrams of example processes 900, 1000, and 1100 for dynamic adaptation according to one or more implementations described herein. Each of processes 900, 1000, and 1100 can be implemented by UE 210 and/or one or more components of UE 210, such as a baseband processor. In some implementations, some or all of any of example processes 900, 1000, and 1100 may be performed by one or more other systems, devices, or functions, including one or more of the devices of FIGS. 2-3. Additionally, processes 900, 1000, and 1100 can include one or more fewer, additional, differently ordered and/or arranged operations than those shown in any of FIGS. 9-11. In some implementations, some or all of the operations of processes 900, 1000, and 1100 may be performed independently, successively, simultaneously, etc., of one or more of the other operations of processes 900, 1000, and 1100. As such, the techniques described herein are not limited to the number, sequence, arrangement, timing, etc., of the operations or processes depicted in any of FIGS. 9-11.

Referring to FIG. 9, process 900 can include determining radio link control (RLC) sojourn time corresponding to at least one protocol data unit (PDU) in a data radio bearer (DRB) queue (block 910). The at least one PDU corresponding to a logical channel (LCH) associated with a data flow. Process 900 can also include determining whether the RLC sojourn time is greater than an RLC sojourn threshold (block 920). Process 900 can also include determining a bit rate adaptation configured to address a difference between the RLC sojourn time and the RLC sojourn threshold when the RLC sojourn time is greater than the RLC sojourn threshold (block 930). Process 900 can further include communicating the bit rate adaptation to an interface with an application processor associated with the LCH and the data flow (block 940).

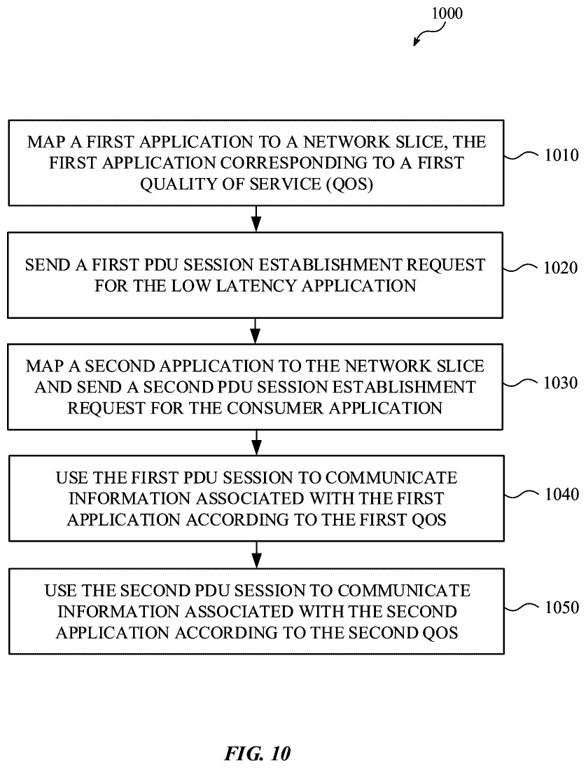

Referring to FIG. 10, process 1000 can include mapping a first application to a network slice, the first application corresponding to a first quality of service (QOS) (block 1010). Process 1000 can also include sending a first protocol data unit (PDU) session establishment request for the low latency application (block 1020). Process 1000 can also include mapping a second application to the network slice, the second application corresponding to a second QoS that is different than the first QoS and sending a second PDU session establishment request for the consumer application (block 1030). Process 1000 can further include using the first PDU session to communicate information associated with the first application according to the first QoS (block 1040). Process 1000 can also include using the second PDU session to communicate information associated with the second application according to the second QoS (block 1050).

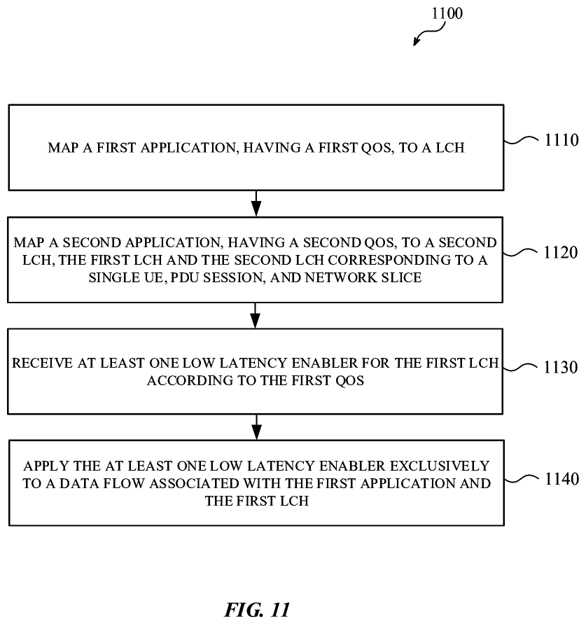

Referring to FIG. 11, process 1100 can include mapping a first application, having a first quality of service (QOS), to a first logical channel (LCH) (block 1110). Process 1100 can also include mapping a second application, having a second QoS, to a second LCH, the first LCH and the second LCH corresponding to a single user equipment (UE) and a single protocol data unit (PDU) session of a single network slice (block 1120). Process 1100 can also include receiving at least one low latency enabler configured according to the first QoS (block 1130). Process 1100 can further include applying the at least one low latency enabler exclusively to a data flow associated with the first application and the first LCH (block 1140).

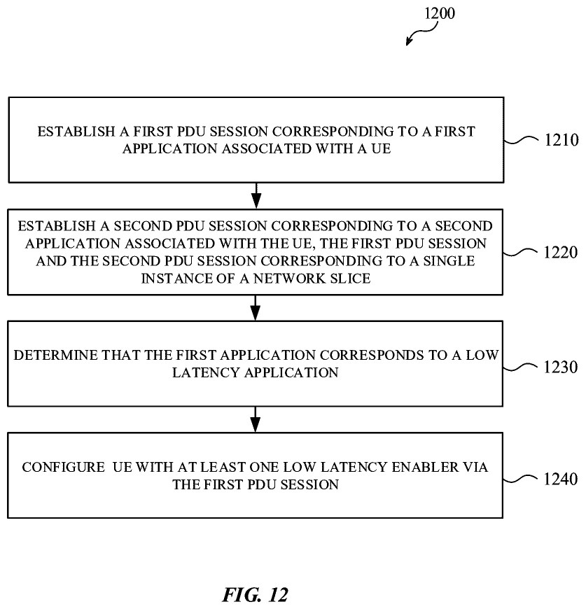

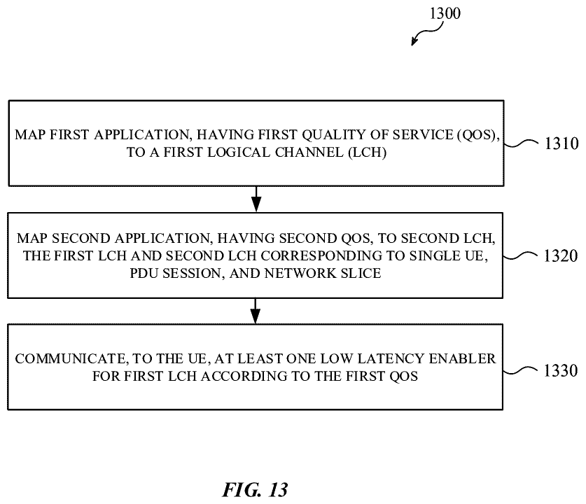

FIG. 12-13 are diagrams of example processes 1200 and 1300 for dynamic adaptation according to one or more implementations described herein. Each of processes 1200 and 1300 can be implemented by base station 222. In some implementations, some or all of any of example processes 1200 and 1300 may be performed by one or more other systems, devices, or functions, including one or more of the devices of FIGS. 12-13. Additionally, processes 1200 and 1300 can include one or more fewer, additional, differently ordered and/or arranged operations than those shown in any of FIGS. 12-13. In some implementations, some or all of the operations of processes 1200 and 1300 may be performed independently, successively, simultaneously, etc., of one or more of the other operations of processes 1200 and 1300. As such, the techniques described herein are not limited to the number, sequence, arrangement, timing, etc., of the operations or processes depicted in any of FIGS. 12-13.

Referring to FIG. 12, process 1200 can include establishing a first protocol data unit (PDU) session corresponding to a first application associated with a user equipment (UE) (block 1210). Process 1200 can include establishing a second PDU session corresponding to a second application associated with the UE, the first PDU session and the second PDU session corresponding to a single instance of a network slice (block 1220). Process 1200 can also include determining that the first application corresponds to a low latency application (block 1230). Process 1200 can also include configuring the UE with at least one low latency enabler via the first PDU session (block 1240).

Referring to FIG. 13, process 1300 can include mapping a first application, having a first quality of service (QOS), to a first logical channel (LCH) (block 1310). Process 1300 can also include mapping a second application, having a second QoS, to a second LCH, the first LCH and the second LCH corresponding to a single user equipment (UE) and a single protocol data unit (PDU) session of a single network slice (block 1320). Process 1300 can also include communicating, to the UE, at least one low latency enabler for the first LCH according to the first QoS (block 1330).

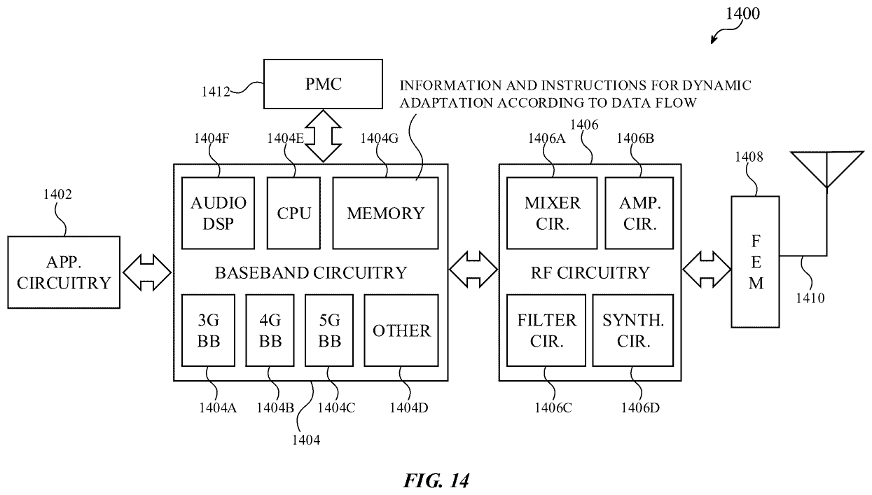

FIG. 14 is a diagram of an example of components of a device according to one or more implementations described herein. In some implementations, the device 1400 can include application circuitry 1402, baseband circuitry 1404, RF circuitry 1406, front-end module (FEM) circuitry 1408, one or more antennas 1410, and power management circuitry (PMC) 1412 coupled together at least as shown. The components of the illustrated device 1400 can be included in a UE or a RAN node. In some implementations, the device 1400 can include fewer elements (e.g., a RAN node may not utilize application circuitry 1402, and instead include a processor/controller to process IP data received from a CN or an Evolved Packet Core (EPC)). In some implementations, the device 1400 can include additional elements such as, for example, memory/storage, display, camera, sensor (including one or more temperature sensors, such as a single temperature sensor, a plurality of temperature sensors at different locations in device 1400, etc.), or input/output (I/O) interface. In other implementations, the components described below can be included in more than one device (e.g., said circuitries can be separately included in more than one device for Cloud-RAN (C-RAN) implementations).

The application circuitry 1402 can include one or more application processors. For example, the application circuitry 1402 can include circuitry such as, but not limited to, one or more single-core or multi-core processors. The processor(s) can include any combination of general-purpose processors and dedicated processors (e.g., graphics processors, application processors, etc.). The processor(s) may include, or be coupled with, a cache memory device and/or another type of temporary storage memory that is local to processor(s). The processors can be coupled with or can include memory/storage device(s) and can be configured to execute instructions stored in the memory/storage to enable various applications or operating systems to run on the device 1400. In some implementations, processors of application circuitry 1402 can process IP data packets received from an EPC.

The baseband circuitry 1404 can include circuitry such as, but not limited to, one or more single-core or multi-core processors. The baseband circuitry 1404 can include one or more baseband processors or control logic to process baseband signals received from a receive signal path of the RF circuitry 1406 and to generate baseband signals for a transmit signal path of the RF circuitry 1406. Baseband circuitry 1404 can interface with the application circuitry 1402 for generation and processing of the baseband signals and for controlling operations of the RF circuitry 1406. For example, in some implementations, the baseband circuitry 1404 can include a 3G baseband processor 1404A, a 4G baseband processor 1404B, a 5G baseband processor 1404C, or other baseband processor(s) 1404D for other existing generations, generations in development or to be developed in the future (e.g., 5G, 6G, etc.). The baseband circuitry 1404 (e.g., one or more baseband processors 1404A-D) can manage various radio control functions that enable communication with one or more radio networks via the RF circuitry 1406. In other implementations, some or all of the functionality of baseband processors 1404A-D can be included in modules stored in the memory 1404G and executed via a central processing unit (CPU) 1404E. The radio control functions can include, but are not limited to, signal modulation/demodulation, encoding/decoding, radio frequency shifting, etc. In some implementations, modulation/demodulation circuitry of the baseband circuitry 1404 can include Fast-Fourier Transform (FFT), precoding, or constellation mapping/de-mapping functionality. In some implementations, encoding/decoding circuitry of the baseband circuitry 1404 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1404G may receive and/or store information and instructions for dynamically adapting processes and resources to different types of channels, data flows, applications, and/or services. For example, baseband circuitry and/or UE 210 may determine a jitter of a LCH based on a corresponding RLC sojourn time, determining a data rate adaptation based on the jitter, and informing a corresponding application of the data rate adaptation. Additionally, or alternatively, baseband circuitry and/or UE 210 can determine and apply a prioritized bit rate for LCHs based on a corresponding jitter. Furthermore, UE 210, base station 222, and/or core network 230 can initiate different PDU sessions and/or LCHs, within the same slice (e.g., a consumer slice), for applications with different QoS requirements and/or KPIs. These and many other features and examples are described in additional detail with reference to the Figures.

In some implementations, the baseband circuitry 1404 can include one or more audio digital signal processor(s) (DSP) 1404F. The audio DSPs 1404F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1404 and the application circuitry 1402 can be implemented together such as, for example, on a system on a chip (SOC).

In some implementations, the baseband circuitry 1404 can provide communication compatible with one or more radio technologies. For example, in some implementations, the baseband circuitry 1404 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1404 is configured to support radio communications of more than one wireless protocol can be referred to as multi-mode baseband circuitry.

RF circuitry 1406 can enable communication with wireless networks using modulated electromagnetic radiation through a non-solid medium. In various implementations, the RF circuitry 1406 can include switches, filters, amplifiers, etc. to facilitate the communication with the wireless network. RF circuitry 1406 can include a receive signal path which can include circuitry to down-convert RF signals received from the FEM circuitry 1408 and provide baseband signals to the baseband circuitry 1404. RF circuitry 1406 can also include a transmit signal path which can include circuitry to up-convert baseband signals provided by the baseband circuitry 1404 and provide RF output signals to the FEM circuitry 1408 for transmission.

In some implementations, the receive signal path of the RF circuitry 1406 can include mixer circuitry 1406A, amplifier circuitry 1406B and filter circuitry 1406C. In some implementations, the transmit signal path of the RF circuitry 1406 can include filter circuitry 1406C and mixer circuitry 1406A. RF circuitry 1406 can also include synthesizer circuitry 1406D for synthesizing a frequency for use by the mixer circuitry 1406A of the receive signal path and the transmit signal path. In some implementations, the mixer circuitry 1406A of the receive signal path can be configured to down-convert RF signals received from the FEM circuitry 1408 based on the synthesized frequency provided by synthesizer circuitry 1406D. The amplifier circuitry 1406B can be configured to amplify the down-converted signals and the filter circuitry 1406C can be a low-pass filter (LPF) or band-pass filter (BPF) configured to remove unwanted signals from the down-converted signals to generate output baseband signals. Output baseband signals can be provided to the baseband circuitry 1404 for further processing. In some implementations, the output baseband signals can be zero-frequency baseband signals, although this is not a requirement. In some implementations, mixer circuitry 1406A of the receive signal path can comprise passive mixers, although the scope of the implementations is not limited in this respect.

In some implementations, the mixer circuitry 1406A of the transmit signal path can be configured to up-convert input baseband signals based on the synthesized frequency provided by the synthesizer circuitry 1406D to generate RF output signals for the FEM circuitry 1408. The baseband signals can be provided by the baseband circuitry 1404 and can be filtered by filter circuitry 1406C.

In some implementations, the mixer circuitry 1406A of the receive signal path and the mixer circuitry 1406A of the transmit signal path can include two or more mixers and can be arranged for quadrature down conversion and up conversion, respectively. In some implementations, the mixer circuitry 1406A of the receive signal path and the mixer circuitry 1406A of the transmit signal path can include two or more mixers and can be arranged for image rejection (e.g., Hartley image rejection). In some implementations, the mixer circuitry 1406A of the receive signal path and the mixer circuitry 1406A can be arranged for direct down conversion and direct up conversion, respectively. In some implementations, the mixer circuitry 1406A of the receive signal path and the mixer circuitry 1406A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1406 can include analog-to-digital converter (ADC) and digital-to-analog converter (DAC) circuitry and the baseband circuitry 1404 can include a digital baseband interface to communicate with the RF circuitry 1406.

In some dual-mode implementations, a separate radio IC circuitry can be provided for processing signals for each spectrum, although the scope of the implementations is not limited in this respect.

In some implementations, the synthesizer circuitry 1406D can be a fractional-N synthesizer or a fractional N/N+1 synthesizer, although the scope of the implementations is not limited in this respect as other types of frequency synthesizers can be suitable. For example, synthesizer circuitry 1406D can be a delta-sigma synthesizer, a frequency multiplier, or a synthesizer comprising a phase-locked loop with a frequency divider.

The synthesizer circuitry 1406D can be configured to synthesize an output frequency for use by the mixer circuitry 1406A of the RF circuitry 1406 based on a frequency input and a divider control input. In some implementations, the synthesizer circuitry 1406D can be a fractional N/N+1 synthesizer.

In some implementations, frequency input can be provided by a voltage-controlled oscillator (VCO), although that is not a requirement. Divider control input can be provided by either the baseband circuitry 1404 or the applications circuitry 1402 depending on the desired output frequency. In some implementations, a divider control input (e.g., N) can be determined from a look-up table based on a channel indicated by the applications circuitry 1402.

Synthesizer circuitry 1406D of the RF circuitry 1406 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1406D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1406 can include an IQ/polar converter.

FEM circuitry 1408 can include a receive signal path which can include circuitry configured to operate on RF signals received from one or more antennas 1410, amplify the received signals and provide the amplified versions of the received signals to the RF circuitry 1406 for further processing. FEM circuitry 1408 can also include a transmit signal path which can include circuitry configured to amplify signals for transmission provided by the RF circuitry 1406 for transmission by one or more of the one or more antennas 1410. In various implementations, the amplification through the transmit or receive signal paths can be done solely in the RF circuitry 1406, solely in the FEM circuitry 1408, or in both the RF circuitry 1406 and the FEM circuitry 1408.

In some implementations, the FEM circuitry 1408 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1406). The transmit signal path of the FEM circuitry 1408 can include a power amplifier (PA) to amplify input RF signals (e.g., provided by RF circuitry 1406), and one or more filters to generate RF signals for subsequent transmission (e.g., by one or more of the one or more antennas 1410).

In some implementations, the PMC 1412 can manage power provided to the baseband circuitry 1404. In particular, the PMC 1412 can control power-source selection, voltage scaling, battery charging, or DC-to-DC conversion. The PMC 1412 can often be included when the device 1400 is capable of being powered by a battery, for example, when the device is included in a UE. The PMC 1412 can increase the power conversion efficiency while providing desirable implementation size and heat dissipation characteristics.

While FIG. 14 shows the PMC 1412 coupled only with the baseband circuitry 1404. However, in other implementations, the PMC 1412 may be additionally or alternatively coupled with, and perform similar power management operations for, other components such as, but not limited to, application circuitry 1402, RF circuitry 1406, or FEM circuitry 1408.

In some implementations, the PMC 1412 can control, or otherwise be part of, various power saving mechanisms of the device 1400. For example, if the device 1400 is in an RRC_Connected state, where it is still connected to the RAN node as it expects to receive traffic shortly, then it can enter a state known as Discontinuous Reception Mode (DRX) after a period of inactivity. During this state, the device 1400 can power down for brief intervals of time and thus save power.

If there is no data traffic activity for an extended period of time, then the device 1400 can transition off to an RRC_Idle state, where it disconnects from the network and does not perform operations such as channel quality feedback, handover, etc. The device 1400 goes into a very low power state and it performs paging where again it periodically wakes up to listen to the network and then powers down again. The device 1400 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1402 and processors of the baseband circuitry 1404 can be used to execute elements of one or more instances of a protocol stack. For example, processors of the baseband circuitry 1404, alone or in combination, can be used execute Layer 3, Layer 2, or Layer 1 functionality, while processors of the baseband circuitry 1404 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

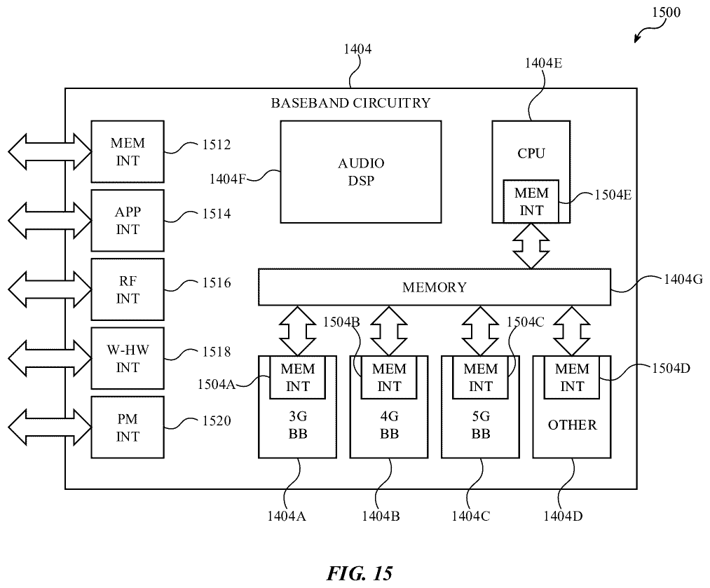

FIG. 15 is a diagram of example interfaces 1500 of baseband circuitry according to one or more implementations described herein. As discussed above, the baseband circuitry 1404 of FIG. 14 can comprise processors 1404A through 1404E and a memory 1404G utilized by said processors. Each of the processors 1404A through 1404E can include a memory interface, 1504A through 1504E, respectively, to send/receive data to/from the memory 1404G.

The baseband circuitry 1404 can further include one or more interfaces to communicatively couple to other circuitries/devices, such as a memory interface 1412 (e.g., an interface to send/receive data to/from memory external to the baseband circuitry 1404), an application circuitry interface 1514 (e.g., an interface to send/receive data to/from the application circuitry 1402 of FIG. 14), an RF circuitry interface 1516 (e.g., an interface to send/receive data to/from RF circuitry 1406 of FIG. 14), a wireless hardware connectivity interface 1518 (e.g., an interface to send/receive data to/from Near Field Communication (NFC) components, Bluetooth® components (e.g., Bluetooth® Low Energy), Wi-Fi® components, and other communication components), and a power management interface 1520 (e.g., an interface to send/receive power or control signals to/from the PMC 1412).

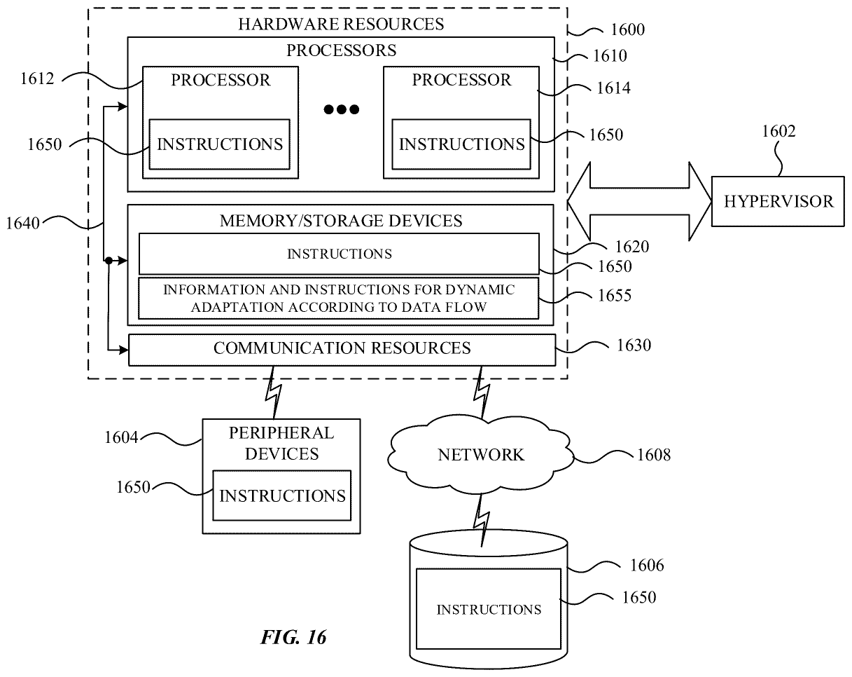

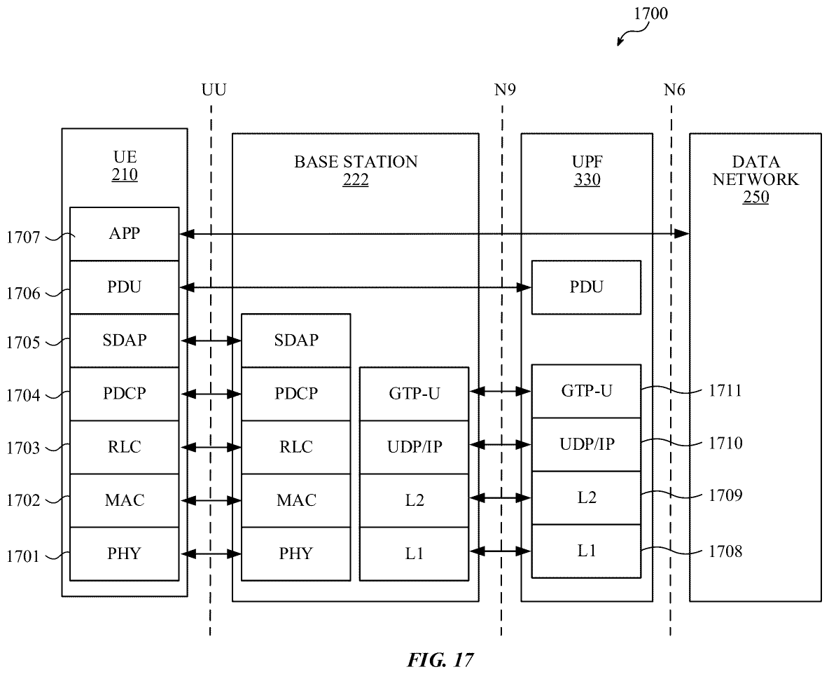

FIG. 16 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 16 shows a diagrammatic representation of hardware resources 1600 including one or more processors (or processor cores) 1610, one or more memory/storage devices 1620, and one or more communication resources 1630, each of which may be communicatively coupled via a bus 1640. For implementations where node virtualization (e.g., NFV) is utilized, a hypervisor may be executed to provide an execution environment for one or more network slices/sub-slices to utilize the hardware resources 1600.

The processors 1610 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1612 and a processor 1614.

The memory/storage devices 1620 may include main memory, disk storage, or any suitable combination thereof. The memory/storage devices 1620 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1620 receive and/or store information and instructions 1655 for dynamically adapting processes and resources to different types of channels, data flows, applications, and services. For example, baseband circuitry and/or UE 210 may determine a jitter of a LCH based on a corresponding RLC sojourn time, determining a data rate adaptation based on the jitter, and informing a corresponding application of the data rate adaptation. Additionally, or alternatively, baseband circuitry and/or UE 210 can determine and apply a prioritized bit rate for LCHs based on a corresponding jitter. Furthermore, UE 210, base station 222, and/or core network 230 can initiate different PDU sessions and/or LCHs, within the same slice (e.g., a consumer slice), for applications with different QoS requirements and/or KPIs. These and many other features and examples are described in additional detail with reference to the Figures.

The communication resources 1630 may include interconnection or network interface components or other suitable devices to communicate with one or more peripheral devices 1604 or one or more databases 1606 via a network 1608. For example, the communication resources 1630 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1650 may comprise software, a program, an application, an applet, an app, or other executable code for causing at least any of the processors 1610 to perform any one or more of the methodologies discussed herein. The instructions 1650 may reside, completely or partially, within at least one of the processors 1610 (e.g., within the processor's cache memory), the memory/storage devices 1620, or any suitable combination thereof. Furthermore, any portion of the instructions 1650 may be transferred to the hardware resources 1600 from any combination of the peripheral devices 1604 or the databases 1606. Accordingly, the memory of processors 1610, the memory/storage devices 1620, the peripheral devices 1604, and the databases 1606 are examples of computer-readable and machine-readable media.

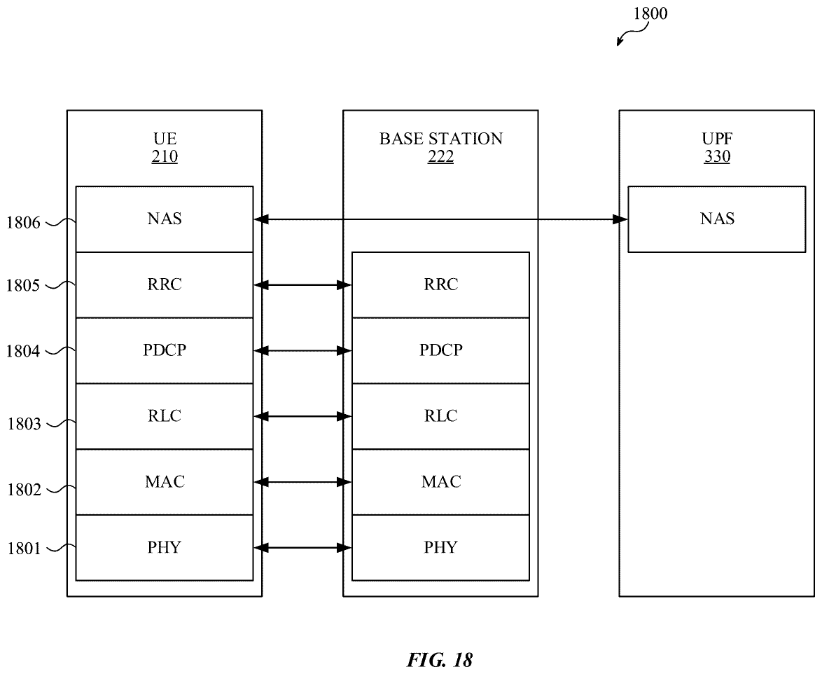

FIG. 18 is a diagram of an example of user plane protocol stack 1800 corresponding to a PDU session in accordance with one or more implementations described herein. User plane protocol stacks 1800 can include a physical (PHY) layer, media access control layer (MAC) layer 1802, radio link control (RLC) layer 1803, packet data convergence protocol (PDCP) layer 1804, service data adaptation protocol (SDAP) layer 1805, protocol data unit (PDU) layer 1806, and application (APP) layer 1807. User plane protocol stacks 1800 can also include a layer 1 (L1) 1808, layer 2 (L2) 1809, user datagram protocol (UDP/IP) layer 1810, and GPRS tunnelling protocol (GTP) for user plane data traffic (GTP-U) layer 1811. User plane protocol stacks 1800 can be implemented as communications protocols between communication devices, such as UE 210, base station 222, one or more UPFs 330, and data network 250.

PHY layer 1801 can transmit or receive information used by MAC layer 1802 over one or more air interfaces. The PHY layer 1801 can further perform link adaptation or adaptive modulation and coding (AMC), power control, cell search (e.g., for initial synchronization and handover purposes), and other measurements used by higher layers, such as RRC layer 1805. PHY layer 1801 can still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

MAC layer 1802 can perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

RLC layer 1803 can operate in a plurality of modes of operation, including: Transparent Mode (TM), Unacknowledged Mode (UM), and/or Acknowledged Mode (AM). RLC layer 1803 can execute transfer of upper layer protocol data units (PDUs), error correction through automatic repeat request (ARQ) for AM data transfers, and concatenation, segmentation and reassembly of RLC SDUs for UM and AM data transfers. The RLC layer 1803 can also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

PDCP layer 1804 can execute header compression and decompression of IP data, maintain PDCP Sequence Numbers (SNs), and perform in-sequence delivery of upper layer PDUs at re-establishment of lower layers. PDCP layer 1804 can also eliminate duplicates of lower layer SDUs at re-establishment of lower layers for radio bearers mapped on RLC AM. PDCP layer 1804 can also cipher and decipher control plane data, perform integrity protection and integrity verification of control plane data, control timer-based discard of data, and perform security operations (e.g., ciphering, deciphering, integrity protection, integrity verification, etc.).

Service data adaptation protocol (SDAP) layer 1805 can exist in the user plane in both gNB and UE. SDAP layer 1805 can interface to upper layers via QoS flows and to the PDCP lower layer via Data Radio Bearers (DRBs). Traffic from QoS flows can be mapped to suitable DRBs. When SDAP layer 1805 receives a PDU from upper layer flow (e.g., TCP/IP), the PDU is associated with QoS for this flow. SDAP layer 1805 can map the flow to a DRB. Similarly, when a PDU is received at the PDCP, the PDU can contain an SDAP header which can be removed, and the PDU is passed to upper layer. PHY layer 1801, MAC layer 1802, RLC layer 1803, PDCP layer, and/or SDAP layer 1805 can correspond to access network (AN) protocol stack. In some implementations, another additional, different, and/or a different arrangement of protocol layers may be used as AN protocol stack.

PDU layer 1806 can correspond to the PDUs carried between UE 210 and a data network (DN) over a PDU session. When the PDU Session type is IP version 4, 6, or 4v6 (IPv4, IPv6, or IPv4v6), the PDU session may correspond to IPv4 packets, IPv6 packets, or both IPv4 and IPv6 packets; when the PDU session type is Ethernet, the PDU session can correspond to Ethernet frames; and so on.

APP layer 1807 can include a protocol for interacting directly with end-user applications and services. APP layer 1807 can provide interfaces for accessing network resources, services, and functionalities. APP layer 1807 can define standard interfaces and protocols for application development, integration, and interoperability. APP layer 1807 can help manage user data and control signaling between UE 210 and the network entities (e.g., base station 222, UPF 333, etc.), to better ensure seamless communication and service delivery. App layer 1807 may represent an application that is executed by UE 210 and that corresponds to a PDU session represented by FIG. 18.

GTP-U layer 1811 can include a protocol for tunnelling user data over an N3 interface (e.g., between base station 222 and UPF 330). While not shown, GTP-U layer 1811 can also include a protocol for tunneling between different instances of UPF 330 over an N9 interface. UDP/IP layer 1810 can include protocols for enabling backbone communications. L1 1808 can include a PHY layer, and L2 1809 can include a data link layer. GTP can encapsulate end user PDUs. GTP-U layer 1811 can provide encapsulation on a per PDU session basis. GTP-U layer 1811 can carry one or more markings associated with a QoS Flow. UDP/IP layer 1810 can include protocols for enabling backbone communications. L1 1808 can include a PHY layer, and L2 1809 can include a data link layer, and vice versa.

FIG. 19 is a diagram of an example of a control plane protocol stack 1900 in accordance with one or more implementations described herein. As shown, control plane protocol stack 1900 can include a physical (PHY) layer, media access control layer (MAC) layer 1902, radio link control (RLC) layer 1903, packet data convergence protocol (PDCP) layer 1904, radio resource control (RRC) layer 1905, and non-access stratum (NAS) layer 1906. Control plane protocol stacks 1900 can be implemented as a communications protocol between UE 210, base station 222, AMF 310, etc. in some implementations, one or more other systems, devices, or functions described herein can implement control plane protocol stack 1900.

The PHY layer 1901 can transmit or receive information used by the MAC layer 1902 over one or more air interfaces. The PHY layer 1901 can further perform link adaptation or adaptive modulation and coding (AMC), power control, cell search (e.g., for initial synchronization and handover purposes), and other measurements used by higher layers, such as the RRC layer 1905. The PHY layer 1901 can still further perform error detection on the transport channels, forward error correction (FEC) coding/decoding of the transport channels, modulation/demodulation of physical channels, interleaving, rate matching, mapping onto physical channels, and multiple input multiple output (MIMO) antenna processing.

The MAC layer 1902 can perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 1903 can operate in a plurality of modes of operation, including: Transparent Mode (TM), Unacknowledged Mode (UM), and/or Acknowledged Mode (AM). The RLC layer 1903 can execute transfer of upper layer protocol data units (PDUs), error correction through automatic repeat request (ARQ) for AM data transfers, and concatenation, segmentation and reassembly of RLC SDUs for UM and AM data transfers. The RLC layer 1903 can also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 1904 can execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 1905 can include broadcast of system information (e.g., included in master information blocks (MIBs) or system information blocks (SIBs) related to the NAS), broadcast of system information related to the access stratum (AS), paging, establishment, maintenance and release of an RRC connection (e.g., RRC connection paging, RRC connection establishment, RRC connection modification, and RRC connection release), establishment, configuration, maintenance and release of point to point radio bearers (RBs), security functions including key management, inter radio access technology (RAT) mobility, and measurement configuration for UE measurement reporting. MIBs and SIBs can comprise one or more information elements (IEs), which can each comprise individual data fields or data structures.

The UE 210 and base station 222 can utilize a Uu interface (e.g., an NR interface) to exchange control plane data via a protocol stack comprising the PHY layer 1901, the MAC layer 1902, the RLC layer 1903, the PDCP layer 1904, and the RRC layer 1905. NAS layer 1906 can include protocols that form the highest stratum of the control plane between the UE and the core network (CN). NAS layer 1906 can support the mobility of UE 210 and the session management procedures to establish and maintain IP connectivity between UE 210 and the network.

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, baseband circuitry can comprise: a memory; and one or more processors configured to, when executing instructions stored in the memory, cause the baseband circuitry to: determine radio link control (RLC) sojourn time corresponding to at least one protocol data unit (PDU) in a data radio bearer (DRB) queue, the at least one PDU corresponding to a logical channel (LCH) associated with a data flow; determine whether the RLC sojourn time is greater than an RLC sojourn threshold; when the RLC sojourn time is greater than the RLC sojourn threshold, determine a bit rate adaption configured to address a difference between the RLC sojourn time and the RLC sojourn threshold, and communicate the bit rate adaption to an interface with an application processor associated with the LCH and the data flow.

In example 2, which may also include one or more of the examples described herein, the one or more processors is configured to cause the baseband circuitry to: continue monitoring RLC sojourn times corresponding to the LCH when the RLC sojourn time is not greater than the RLC sojourn threshold for a the corresponding duration of a PDU session.

In example 3, which may also include one or more of the examples described herein, the one or more processors is configured to cause the baseband circuitry to: monitor for at least one other rate adaptation trigger associated with the LCH; generate, in response to detecting the at least one rate adaptation trigger, an other bit rate adaptation configured to address the at least one rate adaptation trigger; and communicate the other bit rate adaptation to an interface with an application processor associated with the LCH.

In example 4, which may also include one or more of the examples described herein, at least one other rate adaptation trigger comprises at least one of: a measured queue flush rate exceeding a flush rate threshold; a measured a reference signal received power (RSRP) being below an RSRP threshold; and a measured RLC sojourn time exceeding an RLC sojourn time threshold.

In example 5, which may also include one or more of the examples described herein, at least one PDU comprises a plurality of PDUs; and the one or more processors is configured to cause the baseband circuitry to: determine a jitter associated with the DRB queue based on changes in the RLC sojourn times of the plurality of PDUs; and determine whether the RLC sojourn time is greater than an RLC sojourn threshold by determining whether the jitter associated with the DRB queue is greater than a jitter threshold.

In example 6, which may also include one or more of the examples described herein, the bit rate adaptation comprises: an indication of an adaptation in a bit rate to be implemented by the application processor; and an indication of at least one of: a data flow; a PDU session; and the LCH.

In example 7, which may also include one or more of the examples described herein, the DRB queue comprises PDUs associated with a plurality of LCHs and each LCH of the plurality of LCHs is associated with a different data flow, and the one or more processors is configured to cause the baseband circuitry to: determine RLC sojourn times associated with each data flow of a plurality of LCHs; determine whether any of the RLC sojourn times is greater than the RLC sojourn threshold; determine bit rate adaptations for data flows with RLC sojourn times greater than the RLC sojourn threshold; and communicate, via the interface, the bit rate adaptations to application processors associated with the data flows with the RLC sojourn times greater than the RLC sojourn threshold.

In example 8, which may also include one or more of the examples described herein, the bit rate adaptation comprises a change in a bit rate of the data flow.

In example 9, which may also include one or more of the examples described herein, the bit rate adaptation comprises a change in a prioritized bit rate (PBR) associated with the data flow.

In example 10, which may also include one or more of the examples described herein, baseband circuitry can comprise: a memory; and one or more processors configured to, when executing instructions stored in the memory, cause the baseband circuitry to: map a first application to a network slice, the first application corresponding to a first quality of service (QoS); send, to an interface with radio frequency (RF) circuitry, a first protocol data unit (PDU) session establishment request for the low latency application; map a second application to the network slice, the second application corresponding to a second QoS that is different than the first QoS; send, to the interface with the RF circuitry, a second PDU session establishment request for the consumer application; use the first PDU session to communicate information associated with the first application according to the first QoS; and use the second PDU session to communicate information associated with the second application according to the second QoS.

In example 11, which may also include one or more of the examples described herein, the first application comprises a low latency application, the second application comprises a commercial application, and the first QOS comprises a greater QoS than the second QoS.

In example 12, which may also include one or more of the examples described herein, the first PDU session is mapped to a first single network slice selection assistance information (S-NSSAI) and the second PDU session is mapped to a second S-NSSAI, the first S-NSSAI being different than the second S-NSSAI.

In example 13, which may also include one or more of the examples described herein, the first PDU session and the second PDU session are further mapped to a data network name (DNN) associated with the network slice.

In example 14, which may also include one or more of the examples described herein, low latency enablers are configured according to the first QoS and communicated exclusively via the first PDU session.

In example 15, which may also include one or more of the examples described herein, baseband circuitry can comprise: a memory; and one or more processors configured to, when executing instructions stored in the memory, cause the baseband circuitry to: map a first application, having a first quality of service (QOS), to a first logical channel (LCH); map a second application, having a second QoS, to a second LCH, the first LCH and the second LCH corresponding to a single user equipment (UE) and a single protocol data unit (PDU) session of a single network slice; receive at least one low latency enabler configured according to the first QoS; and apply the at least one low latency enabler exclusively to a data flow associated with the first application and the first LCH.

In example 16, which may also include one or more of the examples described herein, the one or more processors is configured to cause the baseband circuitry to: map the first application to the first LCH based on the first QoS; and map the second application to the second LCH based on the second QoS.

In example 17, which may also include one or more of the examples described herein, the first application is mapped to the first LCH based on a first prioritized bit rate (PBR), and the second application is mapped to the second LCH based on a second PBR, the first PBR being different than the second PBR.

In example 18, which may also include one or more of the examples described herein, the one or more processors is configured to cause the baseband circuitry to: map the first application to a first application class based on a first prioritized bit rate (PBR); and map the second application to a second application class based on a second prioritized bit rate (PBR).

In example 19, which may also include one or more of the examples described herein, a user equipment can comprise: a memory; and one or more processors configured to, when executing instructions stored in the memory, cause the UE to: determine a radio link control (RLC) sojourn time corresponding to a at least one protocol data unit (PDU) in a data radio bearer (DRB) queue, the at least one PDU corresponding to a logical channel (LCH); determine whether the RLC sojourn time is greater than an RLC sojourn threshold; when the RLC sojourn time is greater than the RLC sojourn threshold, determine a bit rate adaptation configured to address a difference between the RLC sojourn time and the RLC sojourn threshold, and change a data flow associated with the LCH based on the bit rate adaptation.

In example 20, which may also include one or more of the examples described herein, a base station can comprise: a memory; and one or more processors configured to, when executing instructions stored in the memory, cause the base station to: establish a first protocol data unit (PDU) session corresponding to a first application associated with a user equipment (UE); establish a second PDU session corresponding to a second application associated with the UE, the first PDU session and the second PDU session corresponding to a single instance of a network slice; determine that the first application corresponds to a low latency application; and configure the UE with at least one low latency enabler via the first PDU session.

In example 21, which may also include one or more of the examples described herein, the one or more processors is configured to cause the base station to: establish the first PDU session in response to receiving a first PDU session establishment request and associate the first PDU session with: a data network name (DNN) of the single instance of the network slice; and a first single network slice selection assistance information (S-NSSAI); and establish the second PDU session in response to receiving a second PDU session establishment request and associate the first PDU session with: the DNN of the single instance of the network slice; and a second S-NSSAI.

In example 22, which may also include one or more of the examples described herein, the one or more processors is configured to cause the base station to: determine that the second application correspond to a commercial application associated with a lower QoS than a QoS associated with the first application.

In example 23, which may also include one or more of the examples described herein, a base station can comprise: a memory; and one or more processors configured to, when executing instructions stored in the memory, cause the base station to: map a first application, having a first quality of service (QOS), to a first logical channel (LCH); map a second application, having a second QoS, to a second LCH, the first LCH and the second LCH corresponding to a single user equipment (UE) and a single protocol data unit (PDU) session of a single network slice; and communicate, to the UE, at least one low latency enabler for the first LCH according to the first QoS.

In example 24, which may also include one or more of the examples described herein, the one or more processors is configured to cause the base station to: determine, based on the first QoS, a first class of the first application; map the first application to the first LCH based on the first class of the first application; determine, based on the second QoS, a second class of the second application; and map the second application to the second LCH based on the second class of the second application.

In example 25, which may also include one or more of the examples described herein, the first application is mapped to the first LCH based on a first prioritized bit rate (PBR), and the second application is mapped to the second LCH based on a second PBR, the first PBR being different than the second PBR.

In example 26, which may also include one or more of the examples described herein, the first application is mapped to a first type of application that corresponds to a first prioritized bit rate (PBR), the second application is associated with a second type of application that corresponds to a second PBR, the first PBR being different than the second PBR, the first application is mapped to the first LCH based on the first type of application, and the second application is mapped to the second LCH based on the second type of application.

The examples discussed above also extend to method, computer-readable medium, and means-plus-function claims and implementations, an of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. Baseband circuitry, comprising:
a memory; and
one or more processors configured to, when executing instructions stored in the memory, cause the baseband circuitry to:
determine radio link control (RLC) sojourn time corresponding to at least one protocol data unit (PDU) in a data radio bearer (DRB) queue, the at least one PDU corresponding to a logical channel (LCH) associated with a data flow;
determine whether the RLC sojourn time is greater than an RLC sojourn threshold;
when the RLC sojourn time is greater than the RLC sojourn threshold,
determine a bit rate adaption configured to address a difference between the RLC sojourn time and the RLC sojourn threshold, and
communicate the bit rate adaption to an interface with an application processor associated with the LCH and the data flow.

2. The baseband circuitry of claim 1, wherein the one or more processors is configured to cause the baseband circuitry to:
continue monitoring RLC sojourn times corresponding to the LCH when the RLC sojourn time is not greater than the RLC sojourn threshold for a the corresponding duration of a PDU session.

3. The baseband circuitry of claim 1, wherein the one or more processors is configured to cause the baseband circuitry to:
monitor for at least one other rate adaptation trigger associated with the LCH;
generate, in response to detecting the at least one rate adaptation trigger, an other bit rate adaptation configured to address the at least one rate adaptation trigger; and
communicate the other bit rate adaptation to an interface with an application processor associated with the LCH.

4. The baseband circuitry of claim 3, wherein the at least one other rate adaptation trigger comprises at least one of:
a measured queue flush rate exceeding a flush rate threshold;
a measured a reference signal received power (RSRP) being below an RSRP threshold; and
a measured RLC sojourn time exceeding an RLC sojourn time threshold.

5. The baseband circuitry of claim 1, wherein:
the at least one PDU comprises a plurality of PDUs; and
the one or more processors is configured to cause the baseband circuitry to:
determine a jitter associated with the DRB queue based on changes in the RLC sojourn times of the plurality of PDUs; and
determine whether the RLC sojourn time is greater than an RLC sojourn threshold by determining whether the jitter associated with the DRB queue is greater than a jitter threshold.

6. The baseband circuitry of claim 1, wherein the bit rate adaptation comprises:
an indication of an adaptation in a bit rate to be implemented by the application processor; and
an indication of at least one of:
a data flow;
a PDU session; and
the LCH.

7. The baseband circuitry of claim 1, wherein the DRB queue comprises PDUs associated with a plurality of LCHs and each LCH of the plurality of LCHs is associated with a different data flow, and
the one or more processors is configured to cause the baseband circuitry to:
determine RLC sojourn times associated with each data flow of a plurality of LCHs;
determine whether any of the RLC sojourn times is greater than the RLC sojourn threshold;
determine bit rate adaptations for data flows with RLC sojourn times greater than the RLC sojourn threshold; and
communicate, via the interface, the bit rate adaptations to application processors associated with the data flows with the RLC sojourn times greater than the RLC sojourn threshold.

8. The baseband circuitry of claim 1, wherein the bit rate adaptation comprises a change in a bit rate of the data flow.

9. The baseband circuitry of claim 1, wherein the bit rate adaptation comprises a change in a prioritized bit rate (PBR) associated with the data flow.

10. Baseband circuitry, comprising:
a memory; and
one or more processors configured to, when executing instructions stored in the memory, cause the baseband circuitry to:
map a first application to a network slice, the first application corresponding to a first quality of service (QOS);
send, to an interface with radio frequency (RF) circuitry, a first protocol data unit (PDU) session establishment request for the low latency application;
map a second application to the network slice, the second application corresponding to a second QoS that is different than the first QoS;
send, to the interface with the RF circuitry, a second PDU session establishment request for the consumer application;
use the first PDU session to communicate information associated with the first application according to the first QoS; and
use the second PDU session to communicate information associated with the second application according to the second QoS.

11. The baseband circuitry of claim 10, wherein:
the first application comprises a low latency application,
the second application comprises a commercial application, and
the first QoS comprises a greater QoS than the second QoS.

12. The baseband circuitry of claim 10, wherein the first PDU session is mapped to a first single network slice selection assistance information (S-NSSAI) and the second PDU session is mapped to a second S-NSSAI, the first S-NSSAI being different than the second S-NSSAI.

13. The baseband circuitry of claim 12, wherein the first PDU session and the second PDU session are further mapped to a data network name (DNN) associated with the network slice.

14. The baseband circuitry of claim 10, wherein low latency enablers are configured according to the first QoS and communicated exclusively via the first PDU session.

15. Baseband circuitry, comprising:
a memory; and
one or more processors configured to, when executing instructions stored in the memory, cause the baseband circuitry to:
map a first application, having a first quality of service (QOS), to a first logical channel (LCH);
map a second application, having a second QoS, to a second LCH, the first LCH and the second LCH corresponding to a single user equipment (UE) and a single protocol data unit (PDU) session of a single network slice;
receive at least one low latency enabler configured according to the first QoS; and
apply the at least one low latency enabler exclusively to a data flow associated with the first application and the first LCH.

16. The baseband circuitry of claim 15, wherein the one or more processors is configured to cause the baseband circuitry to:
map the first application to the first LCH based on the first QoS; and
map the second application to the second LCH based on the second QoS.

17. The baseband circuitry of claim 15, wherein:
the first application is mapped to the first LCH based on a first prioritized bit rate (PBR), and
the second application is mapped to the second LCH based on a second PBR, the first PBR being different than the second PBR.

18. The baseband circuitry of claim 15, wherein the one or more processors is configured to cause the baseband circuitry to:
map the first application to a first application class based on a first prioritized bit rate (PBR); and
map the second application to a second application class based on a second prioritized bit rate (PBR).
